(19) United States
(12) Patent Application Publication
(10) Pub. No.: US 2025/0342386 A1
(43) Pub. Date: Nov. 6, 2025

(54) ARTIFICIAL INTELLIGENCE EVENT CLASSIFICATION AND RESPONSE

(71) Applicant: Tabor Mountain LLC, Wilmington, DE (US)

(72) Inventors: William Delmonico, Burnsville, MN (US); Joseph Schmitt, Princeton, MN (US); Michael Kramer, Princeton, MN (US); Randall Kurtz, Big Lake, MN (US)

(21) Appl. No.: 18/652,132

(22) Filed: May 1, 2024

(51) Int. Cl. G06N 20/00

(52) U.S. Cl. CPC G06N 20/00

(57) ABSTRACT

Disclosed are system and techniques for classifying events such as emergencies. A system can include a computer system to perform operations including: receiving sensor signals from a group of devices at a location, determining whether one or more of the sensor signals exceed expected threshold levels, in response to determining that the one or more of the sensor signals exceed the expected threshold levels, correlating the sensor signals, classifying the correlated sensor signals into an emergency event based on applying an artificial intelligence (AI) model to the correlated sensor signals, the AI model having been trained to classify the correlated sensor signals into a type of emergency, determine a spread of the emergency event, and determine a severity level of the emergency event, generating, based on information associated with the classified emergency event as output from the AI model, emergency response information, and returning the emergency response information.

### TECHNICAL FIELD

This disclosure generally describes devices, systems, and methods related to classifying events and automatically generating responses to the classified events using artificial intelligence (AI) and machine learning techniques.

### BACKGROUND

Events and/or emergencies can occur in various locations, such as buildings, schools, hospitals, homes, and/or public spaces, at unexpected times. Such events may include fires, gas leaks, water leaks, carbon monoxide, burglary, theft, break-ins, active shooters, or other situations that can compromise not safety and wellbeing of users at a location of the emergency. Users may not know about or have emergency response plans before the event (e.g., emergency) may occur. In some cases, the users may be temporary visitors or customers. Such users may not know a floorplan of the location, safe exits, how to exit in the event of an emergency, where they can seek safety at the location, and/or whether the location is at risk of experiencing an emergency. In some cases, the users can include full-time residents or frequent visitors, however they may not be aware of conditions at the location that may cause an emergency to occur and/or they may not be aware of how to respond or reach safety in the event that an emergency does occur. Therefore, the users may not be prepared should an emergency arise at the location while they are present.

Should an emergency occur, the users at the location of the emergency may be surprised and/or disoriented. The users may become confused, not knowing how to safely exit the location or stay in place to avoid the emergency. Sometimes during emergencies, such as fires or active shooter situations, emergency advisement devices may malfunction, not work, or otherwise become immobilized as a result of the emergency. When this happens, the users may not receive guidance directing them to exit the location or remain in place both safely and quickly. As a result, the user's lives, mental wellbeing, and physical wellbeing may be put at risk.

When an emergency or other type of event occurs, emergency responders may require directions and other relevant information in order to properly respond to the emergency and help the users at the location of the emergency. Sometimes, there can be a lag in providing necessary information to the emergency responders. Sometimes, the necessary information may be incomplete and thus can make it challenging for the emergency responders to understand the emergency, how the emergency impacts the users at the location of the emergency, how the emergency responders can quickly and safely assist the users in reaching safety, and/or how the emergency responders can quickly and safely mitigate the emergency.

### SUMMARY

The disclosure generally describes technology for classifying events, or emergencies, and automatically generating responses to the classified events using AI and machine learning techniques. The AI and machine learning techniques can be deployed on the edge to provide for real-time or near real-time monitoring of conditions and emergency response, thereby decreasing time needed to detect and respond to an emergency while ensuring the safety and wellbeing of relevant users.

More specifically, the disclosed technology can provide a comprehensive system deployed on the edge in a location such as building, school, hospital, home, and/or public space to passively monitor for emergencies or other unusual conditions in the location. The system may include an edge computing device that can communicate with sensor devices positioned throughout the location to receive sensor signals and process the received signals. The edge device can process the signals using AI techniques and/or machine learning models to detect an emergency or other type of event, classify the emergency, and determine appropriate response(s) to the detected and classified emergency in real-time or near real-time. Determining responses to the emergency may include automatically generating and transmitting emergency response information to emergency responders (e.g., firefighters, police, EMTs). The emergency response information can provide guidance, including but not limited to details about where the emergency is located, how the emergency is expected to spread, where users are located relative to the emergency and/or the emergency spread, how to enter the location of the emergency, how to assist the users at the location, and/or how to mitigate or stop the emergency from spreading. The edge device may generate emergency response information for the users at the location of the emergency, including instructions to stay in place and/or safely egress from the location. Any of the emergency response information described herein can be provided as notifications at user devices of the emergency responders and/or the users at the location of the emergency, as audio and/or visual cues outputted by the sensor devices at the location of the emergency, and/or as holograms, augmented reality (AR), and/or virtual reality (VR) at the user devices and/or the sensor devices.

As an illustrate example, a location can be equipped with a group of sensor devices that may be designed to unobtrusively monitor for conditions in their proximate area (e.g., within a room where the sensor devices are located in a building), such as through being embedded within a light switch, outlet cover, light fixture, and/or other preexisting devices, structures, and/or features within a premises. Such sensor devices can include a collection of sensors that can be configured to detect various conditions, such as microphones to detect sound, cameras to detect visual changes, light sensors to detect changes in lighting conditions, motion sensors to detect nearby motion, temperature sensors to detect changes in temperature, accelerometers to detect movement of the devices themselves, and/or other sensors. Such sensor devices can additionally include signaling components capable of outputting information to users that are nearby, such as speakers, projectors, and/or lights. These signaling components can output information, such as information identifying safe pathways for emergency egress and/or stay-in-place orders at the location.

The sensor devices can be positioned throughout the location and can provide signals about an environment within the location to the edge device. The edge device can sometimes be one of the sensor devices. The edge device can apply one or more AI and/or machine learning techniques to combine and use the signals to collectively detect emergencies it the location and to distinguish between the emergency event and non-emergency events. The edge device can generate and transmit alerts/notifications/instructions and/or emergency response information to devices associated with the location (e.g., building automation devices, mobile devices, smart devices, etc.), emergency responders' devices, and/or devices of users associated with the location. The disclosed technology can also include an AR interface to provide users (at the location and/or emergency responders) with information about a detected emergency.

One or more embodiments described herein can include a system for classifying emergencies, the system including: a backend computer system that can be configured to perform operations including: receiving, different types of sensor signals from a group of devices at a group of locations, retrieving expected conditions information associated with the group of locations, identifying deviations in the different types of sensor signals from the expected conditions information, annotating the different types of sensor signals with different types of emergencies based on the identified deviations, correlating the annotated sensor signals based on the different types of emergencies, training an artificial intelligence (AI) model to classify the annotated sensor signals into the different types of emergencies based on the correlated sensor signals, the training further including training the AI model to determine a spread of each of the different types of emergencies and determine a severity level of each of the different types of emergencies, and returning the trained AI model for runtime deployment. The system can also include an edge computing device that can be configured to perform operations during the runtime deployment including: receiving sensor signals from a group of devices at a location, determining whether one or more of the sensor signals exceed expected threshold levels, in response to determining that the one or more of the sensor signals exceed the expected threshold levels, correlating the sensor signals, classifying the correlated sensor signals into an emergency event based on applying the AI model to the correlated sensor signals, where classifying the correlated sensor signals into the emergency event can include: determining a type of the emergency event, determining a spread of the emergency event at the location, and determining a severity level of the emergency event, generating, based on the determine type, spread, and severity of the classified emergency event, emergency response information, and returning the emergency response information.

In some implementations, the embodiments described herein can optionally include one or more of the following features. The backend computer system can also: generate synthetic training data indicating one or more other types of emergencies, and train the AI model based on the synthetic training data. Returning the emergency response information can include automatically transmitting the emergency response information to computing devices of users at the location of the classified emergency event. The computing devices of the users can be configured to output the emergency response information using at least one of audio signals, text, haptic feedback, holograms, augmented reality (AR), or virtual reality (VR). Returning the emergency response information can include: identifying, based on the emergency response information, relevant emergency responders to provide assistance to users at the location of the classified emergency event, and automatically transmitting the emergency response information to a computing device of the identified emergency responders. In some implementations, the emergency response information can include a number of users at the location of the classified emergency event and instructions for assisting the users to response to the classified emergency event. The instructions can include stay in place orders. The instructions can include directions to egress from the location of the classified emergency event.

In response to determining that the one or more of the sensor signals exceed the expected threshold levels, the process further can include: pinging the group of devices at the location for sensor signals captured within a threshold amount of time as the one or more of the sensor signals that exceed the expected threshold levels, and correlating the one or more of the sensor signals with the sensor signals captured within the threshold amount of time. The group of devices at the location may include sensor devices that can be configured to monitor the conditions at the location and generate the sensor signals corresponding to the monitored conditions. The computer system can include the edge computing device in some implementations. The backend computer system can also be configured to iteratively adjust the AI model based at least in part on the emergency response information.

One or more embodiments described herein can include a system for classifying emergencies, the system including: a computer system that can be configured to perform operations including: receiving sensor signals from a group of devices at a location, determining whether one or more of the sensor signals exceed expected threshold levels, in response to determining that the one or more of the sensor signals exceed the expected threshold levels, correlating the sensor signals, classifying the correlated sensor signals into an emergency event based on applying an artificial intelligence (AI) model to the correlated sensor signals, the AI model having been trained to classify the correlated sensor signals into a type of emergency, determine a spread of the emergency event, and determine a severity level of the emergency event, generating, based on information associated with the classified emergency event as output from the AI model, emergency response information, and returning the emergency response information.

The disclosed system may include one or more of the above-mentioned features and/or one or more of the following features. For example, returning the emergency response information can include automatically transmitting the emergency response information to computing devices of users at the location of the classified emergency event.

One or more embodiments described herein can include a method for classifying events, the method including: receiving sensor signals from a group of devices at a location, the group of devices being configured to collect sensor data at the location and process the sensor data to generate the sensor signals, classifying the sensor signals into an event using a mathematical equation, the mathematical equation determining information about the event at the location based upon at least: (i) event parameters that are derived from the use of an artificial intelligence (AI) model and (ii) the sensor signals, and returning the event classification.

The method can optionally include one or more of the above-mentioned features and/or one or more of the following features. For example, the sensor signals can include at least one of: temperature signals from one or more temperature sensors, audio signals from one or more audio sensors, or movement signals from one or more motion sensors. Classifying the sensor signals into an event can include determining a severity level of the event. Classifying the sensor signals into an event can include projecting a spread of the event over one or more periods of time. The event can include an emergency. The AI model could have been trained to generate output indicating the event classification. The method may also include generating, based on the event classification, event response information and transmitting the event response information to a computing device of a user. Transmitting the event response information can include transmitting the event response information to the computing device of an emergency responder. The user can include a user at the location having the event. The event response information can include instructions for guiding the user away from the event at the location.

The devices, system, and techniques described herein may provide one or more of the following advantages. For example, the disclosed technology can incorporate AI, machine learning, and/or AR for lightweight, quick, and accurate emergency or other event detection and response on the edge at any location. Seamless integration with sensor devices and other devices at the location can also provide intuitive and unobtrusive detection of emergencies. Such seamless integration can also make it easier for the users at the location and/or emergency responders to learn about and get updates about current activity on the premises.

Using AI and machine learning, the disclosed technology can provide for accurately identifying types of emergencies, locations of such emergencies, potential spreads of the emergencies, and severity of the emergencies. The edge device can, for example, be trained to classify a detected emergency into different types of emergencies by correlating different signals captured during a similar timeframe and from sensor devices throughout the location. The edge device can, for example, correlate audio signals indicating a sharp increase in sound like a glass window breaking, motion signals indicating sudden movement near a window where the audio signals were captured, and a video feed or other image data showing a body moving near the window where the audio signals were captured to determine where and when a break-in occurred at the location. Classification of the emergency as described herein can advantageously allow for the edge device to identify appropriate action(s) to take, such as notifying the users at the location, notifying emergency responders of the emergency, and/or providing the users and/or the emergency responders with guidance to safely, quickly, and calmly respond to the detected and classified emergency.

As another example, the disclosed technology can generate emergency response plans on the fly, in real-time or near real-time, when emergencies are detected. Dynamic response plans can be generated based on real-time situational information about the users at the location and the edge device's predictions about how the emergency may spread at the location. Real-time information about the emergency can be seamlessly exchanged between the sensor devices, the user devices, and the edge device to ensure that all relevant users made aware of the detected emergency and how to respond appropriately and safely. Similarly, the edge device can leverage AI and machine learning techniques to efficiently and accurately evaluate possible egress routes, select recommended egress route(s), and instruct the sensor devices positioned throughout the premises and/or the user devices to present necessary emergency and egress information. As a result, when the emergency is detected, the edge device may automatically determine optimal ways in which the users can reach safety.

Moreover, the disclosed techniques can provide for passively monitoring conditions at the location to detect emergencies while preserving privacy of the users. Passive monitoring can include collection of anomalous signals, such as changes in lighting, temperature, motion, and/or decibel levels and comparison of those anomalous signals to normal conditions for the location. Using AI and/or machine learning, the edge device can quickly and accurately identify sudden changes in decibel levels and/or temperature levels as indicative of an emergency. The sensor devices, therefore, may be restricted to detect particular types of signals that do not involve higher-fidelity information from the location but enough granularity to provide useful and actionable signals for detecting and classifying emergencies. Thus, the users may not be tracked as they go about their daily lives and their privacy can be preserved.

The disclosed technology also may provide for seamless and unobtrusive integration of sensor devices and existing features at the location. The sensor devices described herein can be integrated into wall outlets, lightbulbs, fans, light switches, and other features that may already exist at the location. Existing sensor devices, such as fire alarms, smoke detectors, temperature sensors, motion sensors, and/or existing security systems can be retrofitted at the location to communicate detected signals with sensor devices, user devices, mobile devices, and the edge device. Such seamless and unobtrusive integration can provide for performing the techniques described throughout this disclosure without interfering with normal activities of users at the location.

To provide robust event/emergency detection and classification, the disclosed technology can use a complex collection of algorithms, AI, and/or machine learning techniques to analyze data related to at least one parameter (e.g., temperature) for a particular location or building to inform users associated with the location of parameters that may be uncommon or atypical for that location. This complex collection of algorithms, AI, and/or machine learning techniques can provide an unconventional solution to the problem of trying to detect and classify emergencies and other events that may occur in a location or building. This unconventional solution can be rooted in technology and provides information that was not available in conventional systems. This unconventional solution also represents an improvement in the subject technical field otherwise unrealized by conventional systems. Specifically, unlike conventional systems, the disclosed technology may detect different types of emergencies and events, severity levels of those emergencies and events, predicted spreads of the emergencies and events, as well as appropriate response strategies and information for the emergencies and events.

After the disclosed technology detects and classifies the emergencies and events, the disclosed technology can display relevant information and data using a GUI on a display of computing devices of the relevant users in a unique and easy way to understand format. Conventional systems may not provide the disclosed solutions for at least the following reasons: (i) the significant processing power required for to continuously monitor a location and detect/classify an event at the location in real-time or near real-time, (ii) the considerable data storage requirements for maintaining information collected and determined by the disclosed technology, (iii) a large enough pool of parameter data to provide accurate thresholds for the disclosed algorithms, AI, and/or machine learning techniques, (iv) algorithms, AI, and/or machine learning techniques that allow for the thresholds to be self-updated in light of additional data that can be added to the pool of relevant parameter data, (v) other hardware and software features discussed below, and/or (vi) other reasons that are known to one of skill in the art based on the disclosure herein.

The complex collection of algorithms, AI, and/or machine learning techniques can be operationally linked and tied to the disclosed technology, which ensures that the disclosed algorithms, AI, and/or machine learning techniques may not preempt all uses of these techniques beyond the disclosed technology. Also, as detailed below, these algorithms, AI, and/or machine learning techniques are complicated and cannot be performed using a pen and paper or within the human mind. In addition, the GUI displays results of the execution of these complex algorithms, AI, and/or machine learning techniques in a manner that can be easily understandable by a human user, sometimes view such results on a small or handheld screen, improve operation of computing devices, etc. Additionally, translation of outcomes from these complex algorithms, AI, and/or machine learning techniques through the GUI onto images or other information displayed for a user improves comprehension of considerable quantities of highly processed data. For example, an exemplary algorithm from this complex collection of algorithms can require: taking inputs from multiple sensors, selecting some data provided by the sensors, ignoring some of the data that was provided by the sensors, performing multiple calculations on a selected subset of the data, combining the data from these multiple calculations and then outputting that data within a short amount of time (e.g., preferably less than a minute), all for multiple relevant users.

The exemplary algorithms, AI, and/or machine learning techniques cannot be performed with a pen and paper or within the human mind because such techniques may require analyzing millions of data points to find similarities amongst events and/or emergencies, determining the parameters associated with the different events and/or emergencies, determining how these parameters change over time to identify severity and/or spread of the events and/or emergencies, obtaining additional data from sensors to identify characteristics of the relevant users and how they may respond to the events and/or emergencies, generating and outputting response information to the relevant users based on the parameters, the severity, the spread, and/or the user characteristics, and then repeating the above operations over a relatively short time period (e.g., every day, every half day, every hour, every 10 minutes, every 5 minutes, every 1 minute) and for many different locations and/or buildings. Additional reasons why this complex collection of algorithms, AI, and/or machine learning techniques cannot be performed with a pen and paper or within the human mind will be obvious to one of skill in the art based on the below disclosure.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of an example system for detecting and classifying emergencies using AI techniques on the edge.

FIG. 2 is a swimlane diagram of a process for real-time detection and classification of an emergency.

FIG. 3 is a flowchart of a process for detecting an emergency in a location such as a building.

FIGS. 4A and 4B is a flowchart of a process for detecting a particular type of emergency from anomalous signals.

FIGS. 5A and 5B is a flowchart of a process for training an AI model to classify emergencies.

FIG. 6 is a flowchart of a process for training a model to detect an emergency and a respective response strategy.

FIGS. 7A, 7B, and 7C depict illustrative guidance presented using AR during an emergency.

FIG. 8 is a flowchart of a process for generating and implementing a training simulation model.

FIG. 9 is a flowchart of a process for implementing and improving a training simulation model.

FIG. 10 is an illustrative GUI display of an emergency training simulation for a user.

FIGS. 11A and 11B are a system diagram of one or more components that can be used to perform the disclosed techniques.

FIG. 12 depicts an example system for training one or more models described herein.

FIG. 13 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to technology for detecting and classifying events such as emergencies in locations such as buildings and/or public spaces on the edge, in real-time or near real-time. The disclosed technology can be deployed on the edge at an edge computing device at the location, at one or more sensor devices positioned at the location, at one or more user and/or mobile devices associated with the location, at a remote computing system, and/or at a cloud-based computing system. Deployment on the edge can allow for the monitoring and emergency detection even when no network connection exists or a network connection has been compromised/lost. Sometimes, the disclosed technology may leverage local network connections, BLUETOOTH, and/or satellite connections to provide communication amongst various devices during an emergency. The disclosed technology can generate emergency response information and instructions once an emergency is detected and classified, and seamlessly/automatically provide that information to relevant stakeholders, including but not limited to emergency responders and users at the location of the emergency. The information can provide guidance to the relevant stakeholders through the use of visual cues, audio cues, textual cues, and/or AR/VR.

The disclosed technology may leverage AI and/or machine learning models, which can be trained to passively and/or continuously assess conditions at the location and classify a detected emergency based on the assessment of the location conditions. The model(s) described herein can be trained and iteratively improved upon to differentiate between different types of emergencies based on processing, analyzing, and correlating disparate and/or anomalous sensor signals (e.g., sound, visual, motion, temperature). The model(s) described herein can also be trained to predict or otherwise infer where the detected emergency may spread, which can be based on a variety of inputs and/or data, including but not limited to building layout or other location information, structural information, historic information about how the emergency may or will spread, etc.

The disclosed technology can apply to different use cases. For example, the disclosed technology may be used to monitor, detect, classify, and respond to active shooter scenarios, fires, water leaks/damage, gas leaks, burglary, theft, break-ins, and other types of emergencies that may arise in locations such as buildings or public spaces (e.g., natural disasters, weather conditions). In brief, in response to detecting active shooter emergencies, the disclosed technology can provide for automatically notifying police of a shooter's location, how many users are nearby the shooter's location, whether the shooter is moving and/or where the shooter is expected to move, and/or how the police can assist the users. A combination of AI, AR/VR, cameras, and/or sensors can be used to provide necessary information to the police and the users to ensure the safety and wellbeing of the users. The disclosed technology can provide for detecting a break-in, detecting where a burglar may move in the building, performing automatic remedial actions such as locking doors with smart locks, and/or communicating with relevant users such as users in the building and/or emergency responders. As another example, the disclosed technology can provide for detecting a fire in a building, where the fire is expected to spread, automatic activation of water supply systems such as sprinklers, and/or communication with users in the building and/or emergency responders to safely mitigate the fire. Similarly, the disclosed technology can provide for detecting a water or gas leak or damage in a building, where the water/gas is expected to spread, automatic shutting down of water supply lines, gas supply lines, and/or valves, and/or communication of the leak/damage with relevant users.

The disclosed technology may apply to detection, classification, and response to different types of emergencies and/or different types of events. Sometimes, the disclosed technology may be used to detect and classify events that may not be identified to a level of emergency. For example, the events may include entering of a home by guests, visitors, and/or occupants, whereas an emergency may include a robbery or other type of break-in.

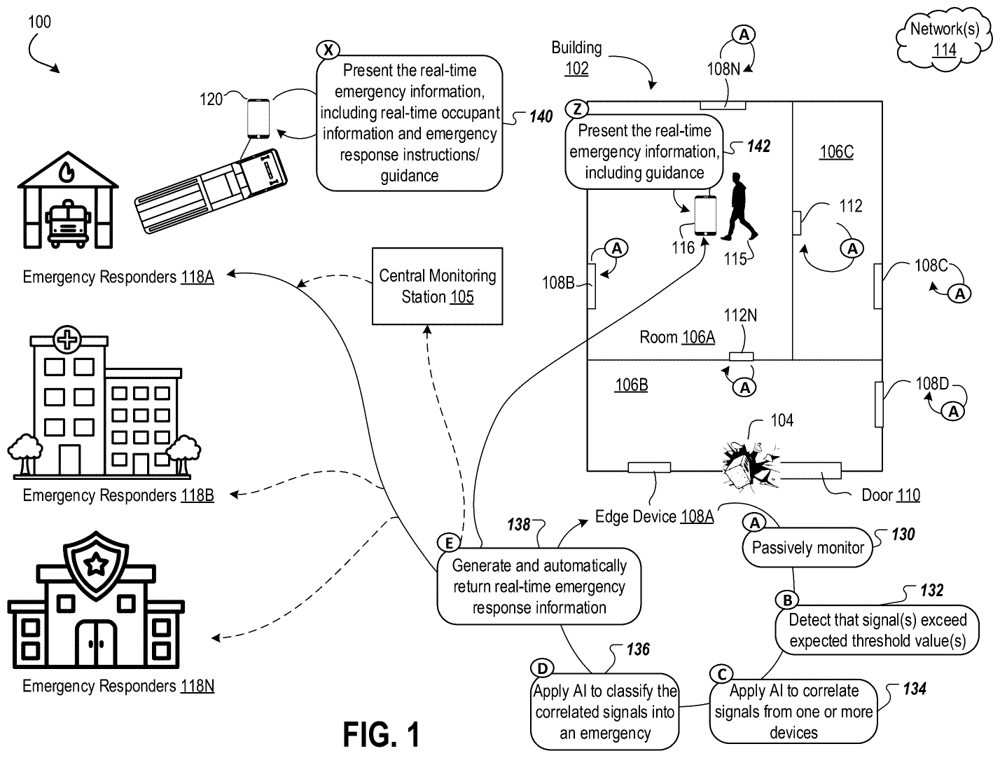

Referring to the figures, FIG. 1 is a conceptual diagram of an example system 100 for detecting and classifying emergencies using AI techniques on the edge. Although FIG. 1 is described from the perspective of a burglary or break-in, the system 100 can also be applied and used in one or more other types of emergencies and events described throughout this disclosure, including but not limited to fires, water leaks, gas leaks, and/or active shooters.

Edge devices 108A-N can be in communication via network(s) 114 with sensor devices 112. In some implementations the edge devices 108A-N can include the sensor devices 112. In other words, the edge devices 108A-N may be the sensor devices 112 and/or vice versa. Communication can be wired and/or wireless (e.g., BLUETOOTH, WIFI, ETHERNET, etc.). Communication can also be through a home network. Sometimes, communication can be through satellite. The edge devices 108A-N may include but are not limited to mobile devices, mobile phones, computers, routers, indoor monitoring systems, security monitoring systems, sensors, network access devices (e.g., wide area network access devices), internet of things (IoT) sensors, cameras, smart cameras, servers, processors, etc.

The sensor devices 112 may include any combination of sensors and/or suite of sensors. For example, the sensor devices 112 may include but are not limited to temperature sensors, humidity sensors, pressure sensors, motion sensors, image sensors, infrared sensors, LiDAR sensors, light sensors, acoustic sensors, or any combination thereof. In some implementations, one or more of the sensor devices 112 may be sensors already installed and/or positioned/located in the building 102. Sometimes, one or more of the sensor devices 112 may be installed in the building 102 before execution of the disclosed techniques.

The edge devices 108A-N and the sensor devices 112 can be configured to continuously and passively monitor conditions and generate sensor signals of activity throughout a building 102. The edge devices 108A-N and the sensor devices 112 can be networked with each other (e.g., via a home network) such that they can communicate with each other. As a result, any of the edge devices 108A-N can, for example, operate to detect an emergency in the building 102, classify the emergency/event, and generate emergency response information for relevant users. Any of the edge devices 108A-N can classify the emergency or other type of event using AI techniques and/or machine learning models described herein. Any of the edge devices 108A-N can be configured to download or otherwise receive the AI techniques and/or machine learning models from a backend computing system via the network(s) 114. Once locally downloaded/available, the AI techniques can be deployed at the edge devices 108A-N for runtime use.

In some implementations, the AI techniques and/or machine learning models, as well as the processing described herein (e.g., detecting an emergency, classifying the emergency, generating emergency response information), can be performed on a chip or processor, such as an AI chip. The AI chip can then be embedded in or otherwise retrofitted to existing sensor devices 112 in the building 102, such as smoke detectors, fire alarms, sprinklers, valves (e.g., water valves, water shutoff valves, solenoid valves), motion detectors, and/or security alarms or security systems. As a result, the disclosed AI techniques, machine learning models, and/or processes can be easily and efficiently deployed in the building 102 using existing infrastructure and without requiring overhead in costs and time to install new edge devices 108A-N and/or sensor devices 112 in the building that perform the disclosed AI techniques, machine learning models, and/or processes.

Sometimes, each of the edge devices 108A-N and/or the sensor devices 112 can take turns operating as the edge device that detects emergencies in the building 102. Sometimes, one of the edge devices 108A-N or the sensor devices 112 can be assigned as the device that detects the emergencies. When a device operates as the device that detects the emergencies, the device can ping or otherwise communicate with the other devices 108A-N and/or 112 to determine when abnormal signals are detected in the building 102, whether an emergency is occurring, and what guidance or instructions can be generated and provided to relevant users.

As described further below, the edge devices 108A-N and the sensor devices 112 can include a suite of sensors that passively monitor different conditions or signals in the building 102. For example, the edge devices 108A-N and the sensor devices 112 can include audio, light, visual, temperature, smoke, and/or motion sensors. Such sensors can pick up on or otherwise detect anomalous and random signals, such as changes in decibels, flashes of light, increases in temperature, strange odors, and/or sudden movements. Therefore, the edge devices 108A-N and the sensor devices 112 may not actively monitor building occupants as they go about with their daily activities. To protect occupant privacy, the edge devices 108A-N and the sensor devices 112 can be limited to and/or restricted to detecting intensities of and/or changes in different types of conditions in the building 102. The edge devices 108A-N and/or the sensor devices 112 may transmit particular subsets of detected information so as to protect against third party exploitation of private information regarding the occupants and the building 102. The edge devices 108A-N and/or the sensor devices 112 can detect and/or transmit information such as changes or deltas in decibel levels, light, motion, movement, temperature, etc., which can then be used by one of the edge devices 108A-N to detect and classify an emergency in the building 102.

The edge devices 108A-N and the sensor devices 112 can be unobtrusively integrated into the building 102. Sometimes, the edge devices 108A-N and the sensor devices 112 can be integrated or retrofitted into existing features in the building 102, such as in light fixtures, light bulbs, light switches, power outlets, and/or outlet covers. The edge devices 108A-N and the sensor devices 112 can also be standalone devices that can be installed in various locations throughout the building 102 so as to not interfere with the daily activities of the building occupants and to be relatively hidden from sight to preserve aesthetic appeal in the building 102. For example, the edge devices 108A-N and/or the sensor devices 112 can be installed in corners, along ceilings, against walls, etc. In the example building 102, the edge devices 108A-N and/or the sensor devices 112 can be positioned in each room 106A, 106B, and 106C. Multiple edge and/or sensor devices can be positioned in each room. Sometimes, only one edge/sensor device may be positioned in a room.

In some implementations, some of the edge devices 108A-N and/or the sensor devices 112 may already be installed in the building 102 before one or more of the edge devices 108A-N and/or the sensor devices 112 are added to the building 102. For example, the sensor devices 112 can include existing security cameras, smoke detectors, fire alarms, user motion sensors, light sensors, etc. Some of the rooms 106A, 106B, and 106C in the building 102 can include such sensor devices 112 while other rooms may not. The edge devices 108A-N may then be added to one or more of the rooms 106A, 106B, and 106C, and synced up to continuously communicate with the existing sensor devices 112. Refer to U.S. application Ser. No. 17/377,213, entitled “Building Security and Emergency Detection and Advisement System,” with a priority date of Jul. 15, 2021 for further discussion, the disclosure of which is incorporated herein by reference in its entirety. Further refer to U.S. application Ser. No. 17/320,751, entitled “Predictive Building Emergency Guidance and Advisement System,” with a priority date of Jun. 16, 2020 for further discussion, the disclosure of which is incorporated herein by reference in its entirety.

In the example system 100 of FIG. 1, the edge device 108A can be selected as the device to detect and classify emergencies in the building 102. Sometimes, the edge device 108A can synchronize clocks of the edge devices 108A-N and/or the sensor devices 112. Synchronization can occur at predetermined times, such as once a day, once every couple hours, at night, and/or during inactive times in the building. To synchronize clocks, the edge device 108A can send a signal with a timestamp of an event to all of the edge devices 108A-N and optionally the sensor devices 112. All the edge devices 108A-N and/or the sensor devices 112 can then synchronize their clocks to the timestamp such that they are on a same schedule. The edge device 108A can also transmit a signal to the edge devices 108A-N and optionally the sensor devices 112 that indicates a local clock time. The edge devices 108A-N and/or the sensor devices 112 can then set their clocks to the same local time. Synchronization makes matching up or linking of detected signals easier and more accurate to detect security events in the building 102. In other words, when security events are detected by the edge devices 108A, timestamps can be attached to detected conditions/information across a normalized scale from each of the other edge devices 108B-N and/or the sensor devices 112. The edge device 108A can accordingly identify relative timing of detected events across the different edge devices 108A-N and/or the sensor devices 112, regardless of where such devices may be located in the building 102.

For example, each of the edge devices 108A-N and/or the sensor devices 112 can passively monitor conditions in the building 102 (block A, 130). Monitoring conditions in the building 102 can include generating sensor signals. The edge devices 108A-N and/or the sensor devices 112 can generate the sensor signals based on processing sensor data that can be collected by the devices 108A-N and/or 112 when monitoring the conditions in the building 102. As an illustrative example, the edge devices 108A-N can collect temperature sensor data (e.g., temperature readings, signal readings, sensor readings) in each of the rooms 106A, 106B, and 106C during one or more times (e.g., every 2 minutes, every 5 minutes, every 10 minutes, etc.), at predetermined time intervals, and/or continuously. The edge devices 108A-N can collect one or more other sensor data as described herein (e.g., motion, light, acoustic/audio/sound, etc.).

As mentioned throughout, the edge devices 108A-N can passively monitor conditions in such a way that protects occupant privacy. The edge devices 108A-N may be limited to and/or restricted from detecting and transmitting particular subsets of information available for sensor-based detection. For example, an audio sensor can be restricted to detect only decibel levels at one or more frequencies (and/or groups of frequencies) instead of detecting and transmitting entire audio waveforms. Similarly, cameras, image sensors, and/or light sensors may be restricted to detecting intensities of and/or changes in light across one or more frequencies and/or ranges of frequencies in the electromagnetic spectrum, such as the visible spectrum, the infrared spectrum, and/or others. Configuring the edge devices 108A-N with such restrictions allows for the devices 108A-N to detect and/or transmit relevant information while at the same time avoiding potential issues related to cybersecurity that, if exploited, could provide an unauthorized third party with access to private information regarding building occupants. Although functionality of sensors within the edge devices 108A-N may be restricted, the edge devices 108A-N can still detect information with sufficient granularity to provide useful and actionable signals for making emergency event determinations and classifications.

The edge device 108A can detect that one or more of the sensor signals generated by the edge devices 108A-N and/or the sensor devices 112 exceeds a respective expected threshold value(s) (block B, 132). In the example of FIG. 1, the edge device 108A can detect an event in the room 106B. The event can be a break-in, which is represented by a brick 104 being thrown through the door 110 and into the room 106B. The edge device 108A can detect the event in a variety of ways. For example, the edge device 108A is passively monitoring sensor signals (block A, 130) in the room 106B, at which point a sharp increase in decibel sensor signals (e.g., readings) may be detected. The sharp increase in decibel sensor signals can indicate the brick 104 being thrown through the door 110 and breaking glass of the door 110. The sharp increase in decibel sensor signals may not be a normal condition or expected sensor signal for the building 102 or the particular room 106B. Thus, the edge device 108A can detect that some abnormal event has occurred in block B (132).

Likewise, the edge device 108A can detect a sudden movement by the door 110, which can represent the brick 104 hitting the door 110 and landing inside of the room 106B. The sudden detected movement may not be a normal condition or expected sensor signal for the building 102, the particular room 106B, and/or at time=1. Thus, the edge device 108A can detect that some abnormal event has occurred in block B (132).

Sometimes, in block B (132), the edge device 108A can receive sensor signals from the other edge devices 108A-N and/or the sensor devices 112. The edge device 108A can combine the generated sensor signals into a collection of signals and determine whether the collection of signals exceeds expected threshold values for the building 102. The edge device 108A can also use relative timing information and physical relationship of the edge devices 108A-N in the building 102 to determine, for the sensor signals or collection of signals that exceed the expected threshold values, a type of security event, a severity of the event, a location of the event, and/or other event-related information.

For example, in block C (134), the edge device 108A can apply AI techniques to correlate the generated sensor signals from the one or more devices 108A-N and/or 112 in the building 102. Correlating the sensor signals can include using AI models described herein to link the sensor signals that deviate from the expected threshold values. For example, the edge device 108A can link together decibel sensor signals from the edge device 108A with motion sensor signals from the edge device 108D and decibel sensor signals from one or more of the other edge devices 108B, 108C, and 108N and/or the sensor devices 112. The edge device 108A can also link together any of the abovementioned sensor signals with video or other image sensor data that can captured by imaging devices inside or outside the building 102. By correlating different types of the generated sensor signals, the edge device 108A can more accurately detect an emergency or other type of at the building 102.

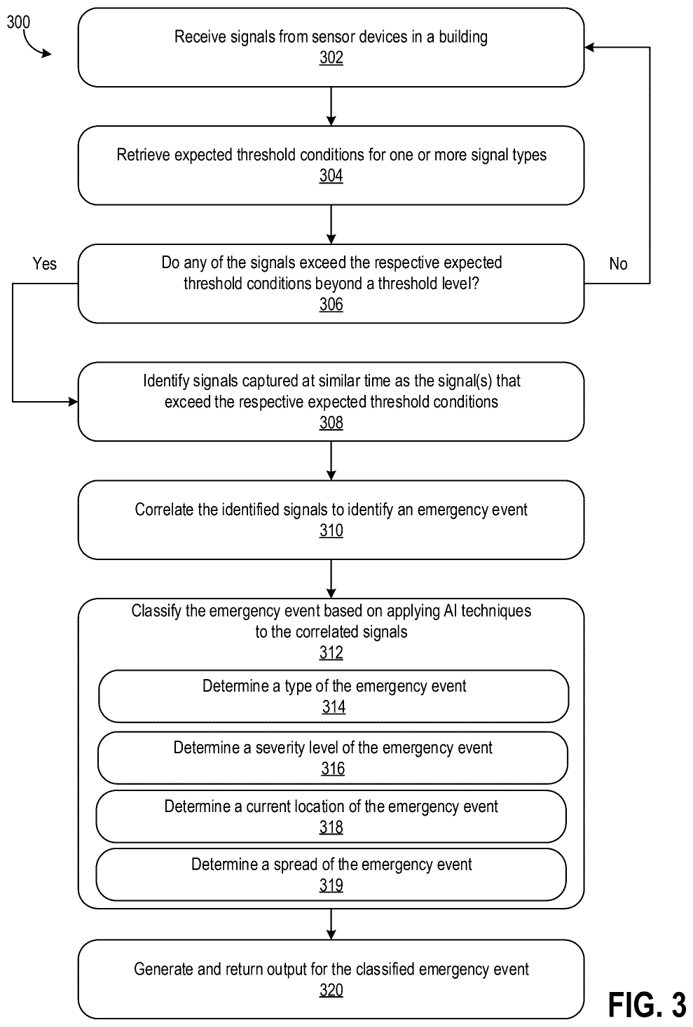

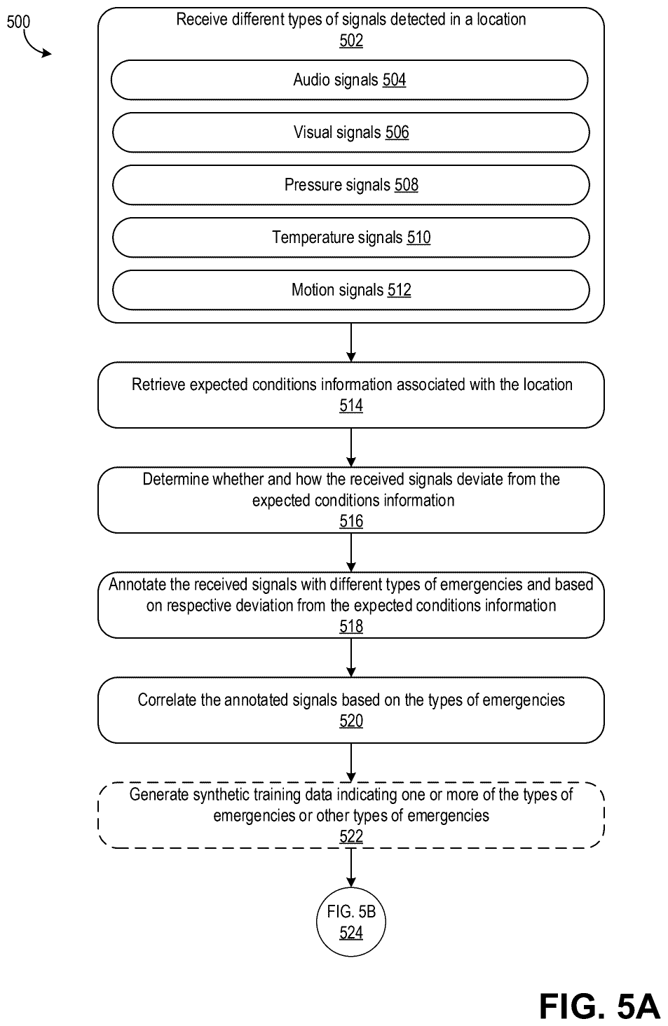

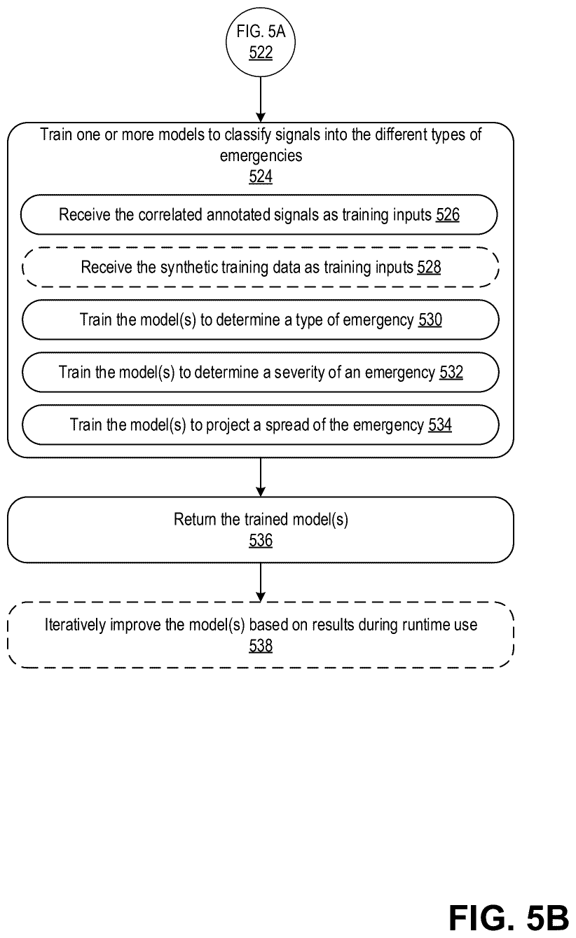

In block D (136), the edge device 108A can apply AI models and techniques to classify the correlated sensor signals into an event, such as an emergency. Refer to FIG. 3 for further discussion about classifying an event in real-time using an AI model. Refer to FIGS. 5A and 5B for further discussion about training the AI model to classify the event.

Referring to both blocks C (134) and D (136), the edge device 108A can use an AI model that was trained to compare the sensor signals to historic sensor signals that correspond to the building 102 and/or the room in which the sensor data was collected and the sensor signal(s) was generated. For a sharp increase in decibel sensor signals in the room 106B, for example, the AI model can be used by the edge device 108A to compare this increase to expected decibel sensor signals for the room 106B. The expected decibel sensor signals for the room 106B can be based on previous decibel sensor data that was detected by the edge device 108A and processed by the edge device 108A to generate the expected decibel sensor signals for the room 106B at the same or similar time (or within a same or similar predetermined period of time or time interval). As another example, if the time associated with the audio sensor signal is 8:30 in the morning, the expected decibel sensor signals can be a historic spread of decibel sensor signals that were generated at 8:30 in the morning over a certain number of days. At 8:30 in the morning, historic changes in decibel sensor signals can be very low because building occupants may still be asleep at that time. Therefore, if the generated decibel sensor signals at this same or similar time is a sudden increase in decibel sensor signals that deviates from the expected sensor signals at the same or similar time, the edge device 108A can determine that the detected sensor signals likely represent some type of emergency or other type of event.

Still referring to both blocks C (134) and D (136), the edge device 108A can use one or more AI and/or machine learning models that are trained to identify a type of emergency or other type of event from different types of sensor signals, correlated sensor signals, changes/deviations in the sensor signals, etc. The model(s) can receive the generated sensor signals as model inputs, process the model inputs, and generate output such as event/emergency classification information. The edge device 108A can categorize the type of emergency based on patterns of the generated sensor signals across different edge devices 108A-N and/or sensor devices 112. The models can be trained using deep learning (DL) neural networks, convolutional neural networks (CNNs), and/or one or more other types of AI, machine learning techniques, methods, and/or algorithms. The models can also be trained using training data that includes sensor signals generated by the edge devices 108A-N and/or the sensor devices 112 in the building 102 or other buildings. The models can be trained to identify and classify events or emergencies based on sensor signals and expected conditions of the particular building 102. The models can also be trained to identify events or emergencies based on sensor signals and expected conditions in a variety of different buildings and/or for a variety of different types of events. Refer to FIGS. 5A and 5B for further discussion about training the models.

The edge device 108A can then generate and automatically return real-time emergency response information in block E (138). In some implementations, the emergency response information can be generated as output from the AI model applied in at least blocks C (134) and/or D (136). Sometimes, for example, the model can generate model output indicating an event classification. The event can be an emergency described herein. The edge device 108A may apply one or more rules and/or criteria to the model output (e.g., the event classification) to generate the emergency response information.

Referring to blocks C (134), D (136), and E (138), the edge device 108A can receive as inputs the generated sensor signals from the edge devices 108A-N and/or the sensor devices 112 in the building 102. These inputs can be provided to the AI model. The AI model can process the inputs to generate and output the event classification, which may include emergency information. The event classification from the AI model can then be processed by the edge device 108A using one or more rules and/or criteria to generate the emergency response information. For example, the model can generate output information, which may include: (i) an indication that an emergency or other event was detected, (ii) a classification or type of emergency, (iii) a severity level of the emergency, (iv) a predicted spread of the emergency, (v) instructions to assist occupants in the building 102 to reach safety and/or to egress from the building 102, (vi) any combination of the above, and/or (vii) any other relevant information. As yet another example, the model can output a notification that can be automatically transmitted to computing devices of relevant emergency responders 118A-N. Any of this output information can be transmitted to a mobile device 116 of a user 115.

Such output information can also be transmitted to and presented/outputted by any of the edge devices 108A-N and/or the sensor devices 112 in the building 102 as visual cues (e.g., holograms), audio cues, AR, and/or VR. The mobile device 116 may, for example, present the real-time or near real-time emergency information, including guidance to help the user 115 calmly and safely reach safety or otherwise mitigate the detected emergency (block Z, 142). Applying the one or more rules and/or criteria, the edge device 108A can determine that the user 115 should receive guidance to safely, calmly, and quickly exit the building 102. The edge device 108A can determine that this guidance should be outputted as text messages at the mobile device 116 instead of audio or visual outputs by the edge devices 108A-N and/or the mobile device 116. The edge device 108A can determine that audio or visual outputs may increase safety risks to the user 115 since it can bring more attention to them. When the edge device 108A provides guidance to help the user 115 safely egress from the building 102, the edge device 108A may also determine optimal egress pathways based on a floorplan of the building 102, a location of the user 115 in the building 102, a projected spread of the emergency, and/or the location of the emergency, as described further below. Any of this guidance can be generated by the edge device 108A as part of the output information from the model and/or the emergency response information described above.

Sometimes, the user 115 can interact with the emergency response information presented at their mobile device 116, such as by providing feedback indicating a false alarm. Such input can be provided back to the edge device 108A, which can communicate with emergency responders 118A-N to change or stop an existing emergency response plan. The user input can also be used to iteratively improve and/or retrain the AI model(s) used herein to detect and classify emergencies and other types of events.

Sometimes, the user 115 can provide input at their mobile device 116 indicating remedial actions that have already been taken by the user 115 or other occupants in the building 102. This input can be received by the edge device 108A and used to dynamically adjust and/or update the emergency response information, the existing emergency response plan, and/or other information about the emergency, such as the emergency classification, severity, and/or predicted spread. The edge device 108A may also use this input to iteratively train and improve the AI model(s) used and described herein.

Similarly, the real-time emergency response information can be transmitted to computing devices 120 or systems of any of the emergency responders 118A-N (e.g., fire fighters, hospital, paramedics, EMT, police). The computing devices 120 of the emergency responders 118A-N can present the real-time or near real-time emergency response information, including occupant information (e.g., where occupants are located in the building relative to the emergency, whether any occupants have disabilities, anxiety, or other conditions that may impact their ability to safely and calmly reach safety) and emergency response instructions and/or guidance (block X, 140). As described herein, any of the emergency response instructions and/or guidance can be provided at the computing devices 120 using text, visual cues, audio cues, haptic feedback, AR, and/or VR. As described above with regard to the user 115 at their device 116, any of the emergency responders 118A-N at their computing devices 120 can also provide input and/or feedback, which can be transmitted to the edge device 108A and used to adjust the emergency response information generated by the edge device 108A and/or the output information provided as output from the AI model(s), and/or iteratively train and improve the AI model(s).

As an illustrative example, the emergency response information transmitted to the computing devices 120 of the emergency responders 118A-N may include images or other information about an active shooter or other threatening individual that may be inside the building 102 or on the premises surrounding the building 102. The images can be captured by cameras associated with the building 102, the edge devices 108A-N, and/or the sensor devices 112. The images may be processed using AI and/or machine learning techniques by the edge device 108A to detect the active shooter or other threatening individual and characteristics or features of the active shooter that may be used by the emergency responders 118A-N to safely and quickly address an emergency at the building 102 involving the active shooter. For example, the edge device 108A may leverage AI techniques that are trained to detect weapons (e.g., firearms, knives, clubs) on or near a body of the active shooter in the captured images. Weapon detection information can be generated and provided to the emergency responders 118A-N before they arrive at the building 102 to help the emergency responders 118A-N adequately address the active shooter upon arrival. The edge device 108A may also use AI techniques that are trained to detect features of the active shooter that may be used by the emergency responders 118A-N to quickly and easily identify the active shooter, including but not limited to clothing, clothing colors, hair color, eye color, body movements, stance, etc. Similar AI techniques may be used to detect and identify features of different types of emergency events, such as fires, to provide the emergency responders 118A-N with information that may help them resolve or otherwise address the emergency events quickly and safely.

In some implementations, the emergency response information may optionally be transmitted by the edge device 108A to a central monitoring station 105 in block E (138). The central monitoring station 105 may then evaluate the transmitted information and, based on the evaluation, transmit the information (or portions thereof) to one or more of the emergency responders 118A-N. The central monitoring station 105 can include one or more computing systems, devices, cloud-based system(s), and/or network of computing systems/devices. For example, the central monitoring station 105 can include one or more servers. The central monitoring station 105 can be configured to ensure that appropriate authorities/personnel are notified on time in the event that fire protection, security, life safety, or other emergency response systems are triggered. In yet some implementations, one or more of the AI techniques described herein can be implemented/executed at the central monitoring station 105. For example, the AI techniques can be implemented at the central monitoring station 105 to classify events/emergencies, determine severity and/or spreads of the events/emergencies, and/or generate output such as emergency response plans, instructions, and other information. Any of the output generated by the central monitoring station 105 can also be provided as and/or transmitted to the emergency responders 118A-N, the mobile device 116 of the user 115, or any other combination thereof of relevant users. The output can be provided as text notifications, emails, haptic feedback, audio output, visual cues/lights/signals, phone calls, etc.

Sometimes, the edge device 108A can transmit the emergency response information to the emergency responders 118A-N, the mobile device 116 of the user 115, and the central monitoring station 105. Sometimes, the edge device 108A can perform an evaluation of the detected emergency in block E (138) to determine whether the detected emergency has severity and/or spread identifications that satisfy one or more emergency threat level criteria. If the detected emergency satisfies the one or more emergency threat level criteria (such as an active shooter in a school), then the edge device 108A may determine to transmit the emergency response information directly to the emergency responders 118A-N and/or the mobile device 116 of the user 115 so that immediate action may be taken. As another example, if the edge device 108A determines that the detected emergency does not satisfy the one or more criteria (an emergency is detected, such as a water leak, but it's projected to spread slowly and/or is not as severe or threatening as other emergency classifications), then the edge device 108A may decide to transmit the emergency response information just to the central monitoring system 105 for further assessment/decision making.

The edge device 108A can leverage AI techniques and modeling in order to make real-time or near real-time decisions about whether to engage emergency responders 118A-N. As a result, monitoring systems and/or stations may be eliminated, which can reduce an amount of time that passes between detecting the emergency and determining whether and how to respond. With the disclosed technology, emergency responders can be engaged quickly and effectively to mitigate the emergency and ensure safety of the occupants in the building 102.

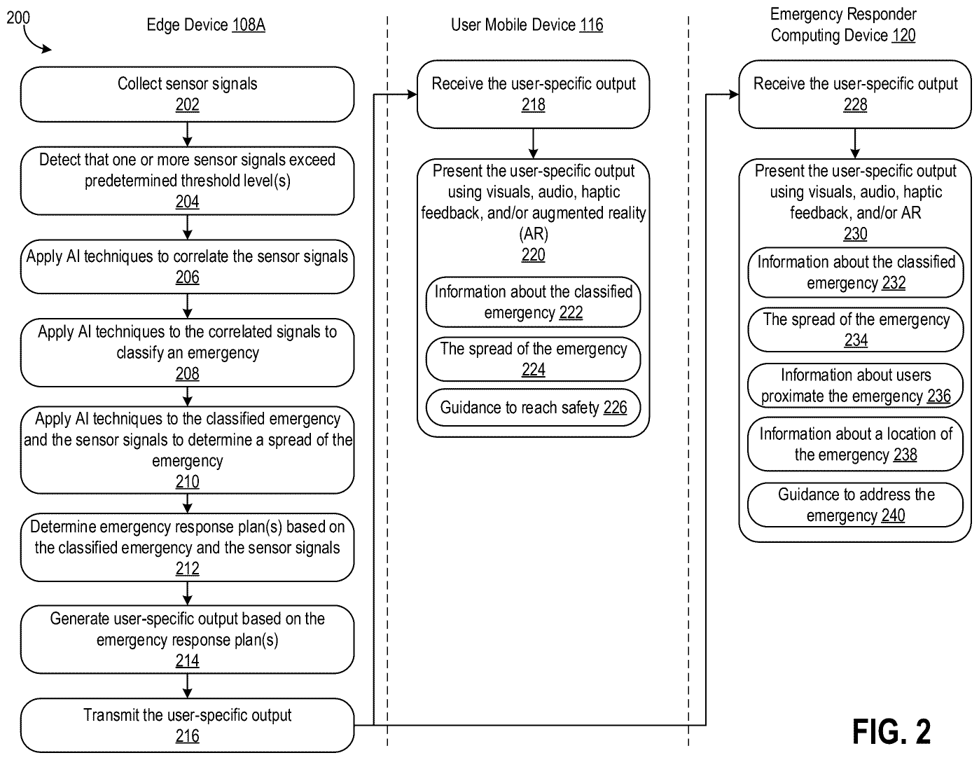

FIG. 2 is a swimlane diagram of a process 200 for real-time detection and classification of an emergency. The process 200 can be performed by one or more system components, such as the edge device 108A, the user mobile device 116, and/or the emergency responder computing device 120 described in reference to at least FIG. 1. The process 200 can also be performed by any one or more other computing systems and/or devices described herein. For example, although not depicted in FIG. 2, the central monitoring station 105 described in reference to FIG. 1 may additionally or alternatively receive output from the edge device 108A about a detected emergency. The central monitoring station 105 can perform similar operations as the user mobile device 116 and/or the emergency responder computing device 120 described in the process 200. Refer to U.S. application Ser. No. 17/346,680, entitled “Predictive Building Emergency Training and Guidance System,” with a priority date of Oct. 7, 2020 for further discussion, the disclosure of which is incorporated herein by reference in its entirety.

Referring to the process 200 in FIG. 2, the edge device 108A can collect sensor signals in block 202. Sensor data can collected by devices at a particular location, then processed by the devices to generate the sensor signals. The sensor signals may then be received from the devices, the devices including but not limited to edge devices, sensor devices, computing devices, and/or mobile devices described herein. Refer to FIG. 1 for further discussion.

In block 204, the edge device 108A may detect that one or more sensor signals exceed respective predetermined threshold level(s). Refer to at least block B (132) in FIG. 1 and process 300 in FIG. 3 for further discussion.

The edge device 108A can accordingly apply AI techniques to correlate the sensor signals that exceed the respective predetermined threshold level(s) in block 206. Refer to at least block C (134) in FIG. 1 and process 300 in FIG. 3 for further discussion. In some implementations, the sensor signals that exceed the respective predetermined threshold level(s) can be provided as inputs to the AI techniques, such as an AI model(s). The AI model(s) can generate output indicating correlated signals.

In block 208, the edge device 108A may apply AI techniques to the correlated signals to classify an emergency or other type of event. Refer to at least block D (136) in FIG. 1 and process 300 in FIG. 3 for further discussion. For example, the output from the AI model(s) in block 206 (the correlated signals) can be provided as input to an AI model in block 208. The AI model in block 208 can generate output indicating emergency classification (or other event classification).

The edge device 108A may also apply AI techniques in block 210 to the classified emergency and/or the sensor signals to determine a spread of the emergency. Refer to at least block D (136) in FIG. 1 and process 300 in FIG. 3 for further discussion. For example, the output from the AI model(s) in block 208 (the emergency classification) can be provided as input to an AI model in block 210. The AI model in block 210 can generate output indicating the spread of the emergency.

The edge device 108A can also determine emergency response plans or other emergency-related information (e.g., the emergency response information in FIG. 1) based on the classified emergency and/or the sensor signals (block 212). The emergency response plan(s) can be determined on the edge, in real-time, and based on output from applying the AI techniques in block 206, 208, and/or 210. For example, the edge device 108A may check the output from any one or more of the AI models that are applied in blocks 206, 208, and/or 210 against one or more rulesets and/or criteria to determine whether to engage emergency responders, which emergency responders to engage, what information to provide to the emergency responders, how to provide the information to the emergency responders, what information to provide to users/occupants at the location of the emergency, how to provide the information to the users, and/or when to provide the information to the users. In some implementations, an AI model can receive, as input, one or more of the AI model outputs described in blocks 206, 208, and/or 210, and generate output that includes the emergency response plans or other emergency-related information. Any of the models described in reference to blocks 206, 208, 210, and/or 212 can be the same AI models, different AI models, or a combination thereof.

When determining whether to engage the emergency responders, the edge device 108A can apply one or more rules and/or criteria for assessing the severity of the detected emergency and/or the classified type of the emergency. The more severe the emergency, for example, a higher confidence value that the edge device 108A would have to engage the emergency responders. Moreover, some types of emergencies, such as fires and/or active shooters can increase the edge device 108A's confidence that emergency responders should be engaged.

When determining which emergency responders to engage, the edge device 108A can assess the classified type of emergency, the spread, and/or the severity of the emergency to determine what type of emergency response is needed (e.g., fire, paramedic, police), identify nearest emergency responder locations, and/or best availability of the nearest emergency responder locations. The edge device 108A may also apply one or more rulesets, criteria, and/or AI techniques to assess travel routes, weather conditions, traffic conditions, and/or other geographic/location-based conditions that may impact an ability of the emergency responds to travel to the location of the emergency within a predetermined period of time.

When determining what information to provide to the emergency responders, the edge device 108A can assess a quantity of users at the location of the emergency, where the emergency was detected at the location, how the emergency is predicted to spread, real-time or near real-time updated sensor signals indicating movement, and/or activities of the users at the location of the emergency. The edge device 108A can generate information such as instructions for traveling to the location of the emergency in the least amount of time, instructions for safely entering the location of the emergency, instructions for remediating the emergency (which can vary based on the classified type of emergency and/or the severity/projected spread), and/or instructions for assisting the users in reaching safety at the location of the emergency. The edge device 108A can also generate training to be deployed at the computing device 120 while the emergency responders are in transit to the location of the emergency. The training can provide instructions to help the emergency responders learn a layout of the location and how to assist the users at the location who may have characteristics impacting their ability to reach safety (e.g., age, disability, athleticism).

When determining how to provide the information to the emergency responders, the edge device 108A can apply one or more rulesets, criteria, and/or AI techniques to determine whether notifications at the computing device 120 are appropriate and/or whether haptic feedback can be provided at the computing device 120 and/or wearable devices of the emergency responders. The edge device 108A can also determine whether audio instructions/commands at the computing device 120, the wearables, headphones, helmets, or other communication devices of the particular emergency responders would be preferred, especially in light of the type of emergency that was detected. The edge device 108A may also determine whether AR/VR can be used to provide the information to the emergency responders via their computing device 120, goggles, watches, glasses, helmets, or other wearable devices.

When determining what information to provide to the users at the location of the emergency, the edge device 108A can apply one or more rulesets, criteria, and/or AI techniques to determine where the emergency was detected, how the emergency is predicted to spread, and/or where and what the users and/or emergency responders are doing at the location of the emergency. Based on such determinations, the edge device 108A may generate and provide instructions to mobile devices of the users for moving to a safe place away from the emergency or the predicted spread of the emergency (e.g., egress guidance, stay in place orders). The edge device 108A may also generate and provide instructions to the users for ensuring their safety while waiting for emergency responders (e.g., going under desks, locking doors, closing lights).

When determining how to provide the information to the users, the edge device 108A can apply one or more rulesets, criteria, and/or AI techniques to determine whether notifications at the user mobile devices is preferred/optimal, whether haptic feedback at the mobile devices and/or wearables should be provided, and/or whether audio instructions or commands should be provided at the mobile devices, wearables, headphones, or other communication devices/sensor devices at locations of the users. Similar to presenting information for the emergency responders, the edge device 108A can also determine whether the information should be provided to one or more of the users using AR/VR provided by the mobile devices, googles, watches, glasses, or other devices of the users. In some implementations, the edge device 108A can determine whether and how to provide holograms through sensor devices at the location of a user and/or the user's mobile device to help the user calmly respond to the emergency.

In determining when to provide the information to the users, the edge device 108A can apply one or more rulesets, criteria, and/or AI techniques to determine whether the information should be provided at the moment the emergency is detected and/or classified, once the emergency responders are contacted, as updates are provided to the edge device 108A by the emergency responders, as locations and/or activities of the users at the location of the emergency change, and/or as the edge device 108A monitors and/or predicts changes of the emergency.

In block 214, the edge device 108A can generate user-specific output based on the emergency response plan(s) or other emergency-related information. The edge device 108A can generate user-specific output that is unique and/or specific to different types of users, including but not limited to occupants/users in the building, police, firefighters, paramedics, and other types of emergency responders, as describe above in reference to block 212.

As an illustrative example, the edge device 108A can apply one or more AI and/or machine learning models to the model output described in blocks 206, 208, and/or 210 (e.g., the output indicating the classified emergency) and/or the sensor signals to determine how any particular occupant at the location of the emergency may respond to the emergency and/or the emergency response plan(s) determined in block 212. Based on how the occupant is likely to respond, the edge device 108A can generate appropriate, user specific guidance as the user-specific output. Such user-specific output can include instructions for the particular occupant to evacuate or stay in place, thereby eliminating a need for the occupant to make such decisions while under stress during the emergency.

The edge device 108A may then transmit the user-specific output in block 216 to the user mobile device 116 and/or the emergency responder computing device 120.

For example, the mobile device 116 can receive the user-specific output in block 218. The mobile device 116 may then present the user-specific output using visuals, audio, haptic feedback, and/or AR/VR in block 220. Sometimes, the mobile device 116 can output holograms to convey the user-specific output received from the edge device 108A. The mobile device 116 can present information about the classified emergency (block 222), information about the spread of the emergency (block 224), and/or guidance to reach safety (block 226). As described herein, the information may also be outputted by other edge devices and/or sensor devices at the location of the emergency. The user-specific output for the users at the location of the building may include AI-generated guidance that can be updated automatically and continuously by the edge device 108A using the disclosed techniques. The guidance can be dynamically modified in real-time or near real-time based on the edge device 108A assessing, using the AI models described herein, conditions of the emergency, how the emergency is projected to spread, user responses/actions during the emergency, and/or emergency responder updates, responses, and/or actions.

The emergency responder computing device 120 can receive the user-specific output in block 228. In block 230, the computing device 120 can present the user-specific output using visuals, audio, haptic feedback, and/or AR/VR (block 230). For example, the computing device 120 can output information about the classified emergency (block 232), the spread of the emergency (block 234), information about users proximate the emergency (e.g., locations of the users, number of the users at the location of the emergency) (block 236), information about a location of the emergency (block 238), and/or guidance to address the emergency (block 240). As described herein, AR can be used at the computing device 120 to provide guidance for the emergency responders before and while at the location of the emergency. In some implementations, the computing device 120 can output emergency and occupant data, the emergency spread prediction, as well as guidance data. In some implementations, the emergency responders can select what information is displayed/outputted at the computing device 120. In yet some implementations, the emergency responders can choose for different information to be displayed at the computing device 120 at different times. The computing device 120 can automatically output new information (e.g., an updated prediction of the emergency spreading) so that the emergency responders may constantly receive pertinent information to respond to the emergency in real-time. Such seamless integration can assist the emergency responders in adequately responding to the emergency without having to make decisions in the moment and under high levels of stress.

FIG. 3 is a flowchart of a process 300 for detecting an emergency in a location such as a building. The process 300 can be performed by the edge device 108A described in at least FIG. 1. The process 300 can also be performed by one or more other edge devices, sensor devices, computing systems, devices, computers, networks, cloud-based systems, and/or cloud-based services. For illustrative purposes, the process 300 is described from the perspective of an edge device.

Referring to the process 300 in FIG. 3, the edge device can receive signals from sensor devices in a building in block 302. As described in reference to FIG. 1, the edge device can receive the signals at predetermined times, such as every 1 minute, 2 minutes, 3 minutes, 4 minutes, 5 minutes, etc. The edge device can automatically receive the signals whenever a sensor or edge device detects a change in state (e.g., a deviation in passively monitored signals) at a location, such as the building. Moreover, the edge device can receive the signals upon transmitting requests for any sensed signals from the sensors or other edge devices. The received signals can include but are not limited to audio (e.g., decibels), visual (e.g., video feed data, image data), light, motion, temperature, water levels, pressure levels, gas levels, and/or smoke signals.

In block 304, the edge device can retrieve expected threshold conditions for one or more signal types. The edge device can retrieve from a data store the expected threshold conditions for each of the received signals. For example, if a light signal is received from a sensor positioned in a kitchen of the building, then the edge device can retrieve the expected threshold condition for light signals in the kitchen of the building. Moreover, the edge device can retrieve the expected threshold conditions for a same or similar timeframe as when the received signals were captured. In the example above, if the light signal is received at 9 pm, then the edge device can retrieve the expected threshold conditions for light in the kitchen at or around 9 pm. Sometimes, the edge device can retrieve overall expected threshold conditions for the building. The overall expected threshold conditions can indicate an average of a particular type of signal or combination of signals that represents a normal state or conditions of the building.

Sometimes, the edge device may learn normal conditions for the building over time. These normal conditions can establish expected threshold conditions or ranges for different types of signals that can be sensed in the building. The expected threshold conditions can be learned in a variety of ways. For example, the expected threshold conditions can be learned using statistical analysis over time. The edge device can analyze signal values detected during one or more periods of time (e.g., 8 am to 9 am every morning for a certain number of consecutive days). The edge device can average, for example, decibel levels during the one or more periods of time, identify spikes or dips in the decibel levels, and categorize those spikes or dips as normal conditions or abnormal conditions. The edge device may also use standard deviations from the historic spread of decibel levels in order to determine expected threshold conditions. In so doing, the edge device can identify typical deviations from the expected threshold conditions that may occur. Any deviation that exceeds the identified typical deviations can be indicative of an emergency.

Sometimes, the expected threshold conditions can be determined and identified as static values rather than averages, standard deviations, and/or ranges of values. Therefore, if the received signals ever exceed a really high static value in a short amount of time, the received signals can be indicative of an emergency. Thus, the edge device can analyze a rate of rise in the received signals to determine whether these signals exceed expected threshold conditions for the building.

In some implementations, the expected threshold conditions may be determined and identified based on relativity. In other words, every few minutes, for example, the edge device can receive decibel signals. The edge device may determine an average in decibel level. Over time, the edge device can determine whether the decibel level is increasing and a rate of rise in decibel level relative to the average decibel level. A sudden and sharp increase in decibel level relative to the average decibel level during a short timeframe can be indicative of an emergency.

The edge device may determine whether any of the received signals exceed the respective expected threshold conditions beyond a threshold level (block 306). Sometimes, the edge device may combine the received signals into a collective of signals. The edge device can then determine whether the collective of signals exceeds expected threshold conditions beyond the threshold level. The threshold level can be predetermined by the edge device and based on the type of signal, a location where the signal was detected, a time of day at which the signal was detected, and one or more factors about the building and/or the building occupants. The threshold level can indicate a range of values that, although deviate from the expected threshold conditions, do not deviate so much as to amount to an emergency. The threshold level can be greater in locations in the building where typically, or on average, there may be more commotion or activity by the building occupants. The threshold level can be lower in locations in the building where typically, or on average, there may be less commotion or activity by the building occupants.

As an illustrative example, temperature signals can have a greater threshold level (e.g., a greater range of expected temperature values) in a bathroom where the temperature can drastically increase when an occupant runs hot water in comparison to a bedroom, where an occupant may only blast A.C. during summer months but otherwise maintain the bedroom at a constant temperature. Therefore, the temperature would have to increase higher and faster in the bathroom than the bedroom in order to trigger identification of an emergency.

As another example, audio signals in a nursery can have a lower threshold level (e.g., a smaller range of expected sound) where typically a young child sleeps in comparison to a family room, which can have a greater threshold level (e.g., a larger range of expected sound) since the occupants typically spend time there, talk, watch TV, and otherwise make a significant amount of noise there. Thus, a lesser deviation in audio signals detected in the nursery can trigger identification of an emergency in comparison to the same deviation in audio signals being detected in the family room.

If none of the signals exceed the respective expected threshold conditions beyond the threshold level, then the edge device can return to performing block 302. In other words, the edge device may determine that conditions are as expected in the building, no emergency has been detected, and the edge device can continue to passively monitor the building conditions.

If, on the other hand, at least one of the signals exceeds the respective expected threshold conditions beyond the threshold level, the edge device can identify signals captured at a similar timeframe as the signal(s) that exceeds the respective expected threshold conditions in block 308.

The edge device may then correlate the identified signals to identify an emergency event in block 310. The correlation can be performed using one or more AI and/or machine learning techniques, as described in reference to FIG. 1. As an illustrative example, if an audio signal detected at a front of the building exceeds the respective expected threshold condition beyond the threshold level, the edge device may also identify an audio signal detected at a back of the building at the same or similar time as the audio signal detected at the front of the building. If the audio signal detected at the back of the building represents a deviation from the expected threshold conditions, albeit a lesser deviation than that of the audio signal detected at the front of the building (e.g., since sound can be more muted farther away from a location of an incident), the edge device can confirm, based on applying the AI models described herein to the audio signals, that the audio signal detected at the front of the building likely constitutes an emergency. As another example, the edge device can identify different types of signals that can be linked into an emergency. Audio, light, and visual signals can be linked together to paint a story of the emergency. One or more other signals can be correlated or otherwise linked together using AI techniques described herein to verify that the emergency event occurred and to depict what happened during the emergency event. Sometimes, the more signals that can be linked to create a robust story of the emergency event can improve confidence and/or ability of the edge device to detect future security events.

In block 312, the edge device can classify the emergency event based on applying AI techniques to the correlated signals. For example, the edge device can determine a type of the emergency event (block 314). The edge device may determine a severity level of the emergency event (block 316). The edge device may determine a current location of the emergency event (block 318). The edge device may determine or project a spread of the emergency event (block 319).

As described herein, the edge device can apply one or more machine learning models and/or AI techniques to the linked signals in order to classify the emergency event. The AI and/or machine learning can be trained to identify a variety of emergency event types from different combinations of signals and deviations in signals for the building and/or other buildings/locations. The AI and/or machine learning may also be trained to identify the type of emergency event based on a variety of factors, such as how much the signals deviate from the expected threshold conditions, what type of signals have been detected, where the detected signals were identified, whether occupants were present or near the signals when detected, etc.

Determining the severity level (block 316) can include analyzing the linked/correlated signals against one or more rulesets, criteria, and/or factors, including but not limited to the type of emergency event and how much the signals deviate from the expected threshold conditions. For example, a temperature signal of such magnitude and rapid rise from the expected threshold temperature condition for the building can indicate that a serious issue, such as a fire, has begun in the building. This event can be assigned a high severity level value. On the other hand, a temperature signal that increases enough to exceed the expected threshold temperature condition over a longer period of time can be identified, by the edge device, as having a lower severity level. The severity level can be a numeric value on a scale, such as between 1 and 100, where 1 is a lowest severity level and 100 is a highest severity level. One or more other scales can be realized and used in the process 300. The severity level can also be a Boolean value and/or a string value. The severity level can indicate how much the identified emergency event poses a threat to the building occupants and/or the building. For example, a higher severity level can be assigned to the identified emergency event when the event threatens safety of the building occupants, protection of the occupant's personal property, and/or structure of the building. As another example, a lower severity level can be assigned to the event when the event threatens a structure of the building but the occupants are not currently present in the building. Therefore, threats that the emergency event poses can be weighed against each other in determining the severity level of the particular emergency event.

Determining the current location of the emergency event (block 318) can include applying one or more AI techniques and/or machine learning models to the linked or correlated signals. For example, using the AI techniques, the edge device may assess strength of the received signals and proximity of the received signals with each other. For example, an audio signal received from a front of the building can greatly exceed threshold conditions for the building while an audio signal received from a back of the building can exceed threshold conditions by a smaller magnitude. The AI techniques can be trained to identify that the emergency event likely occurred closer to the front of the building rather than the back of the building. The edge device may also compare audio signals and other signals received from locations proximate to the audio signal received from the front of the building in order to narrow down and pinpoint a location of the emergency event. Using one or more building layouts (e.g., floor plans) and location information for the sensor/edge devices positioned throughout the building that detected the audio signals, the edge device can identify a room or other particular location in the building where the event occurred. Classifying the event based on type, severity, and location can be beneficial to determine appropriate guidance, instructions, or other information to provide to building occupants and relevant users, such as the emergency responders.

The edge device may generate and return output for the classified emergency event in block 320. Generating the output, as described herein, can include selecting an optimal form of output and determining what information to provide to building occupants or other relevant users, such as the emergency responders. Selecting the optimal form of output can be based on the type of emergency event. For example, if the event is identified as a burglary, the edge device can determine that audio output, whether provided by the sensor devices or the occupants' mobile devices, can expose the occupants to the burglar and increase an associated risk. Therefore, the edge device can select forms of output that include visual displays, text messages, AR, and/or push notifications. As another example, if the event is identified as a fire, the edge device can determine that visual output, as provided by the sensor devices or other sensors/edge devices in the building, may not be preferred since smoke and flames can make it challenging for the building occupants to view lighted signals. The edge device can select forms of output that may include audio instructions or guidance.

In some implementations, the edge device may simply return information about the classified emergency event in block 320 to then be used by the edge device 320 in further processes, such as determining whether to contact the emergency responders and/or a central monitoring station, and/or determining what information to present to the building occupants, the emergency responders, and/or the central monitoring station.

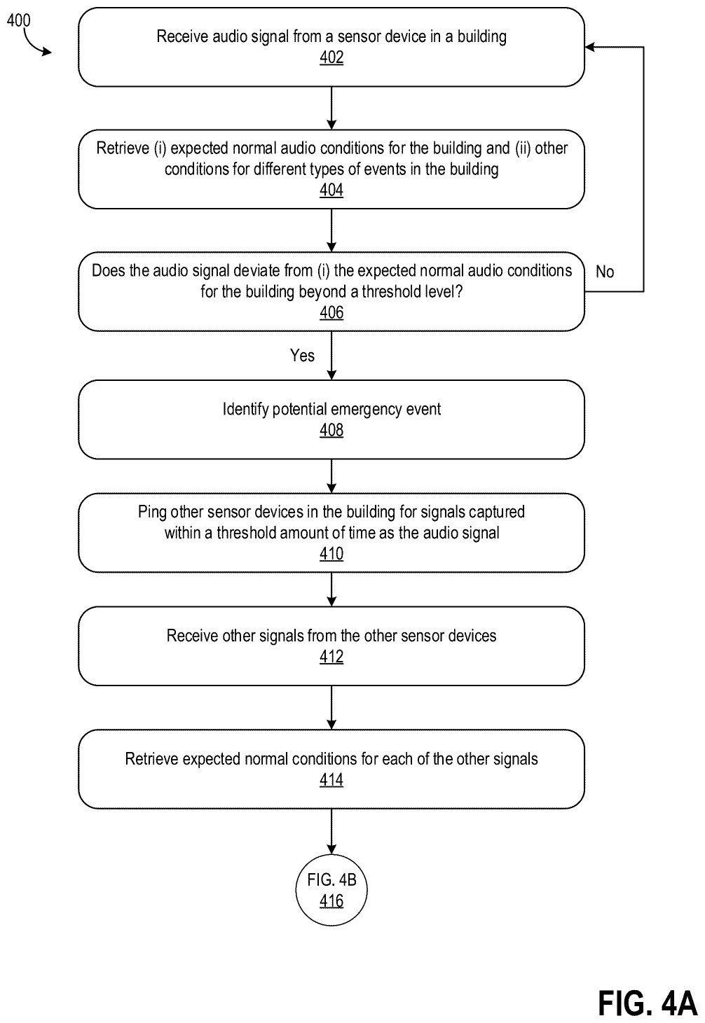

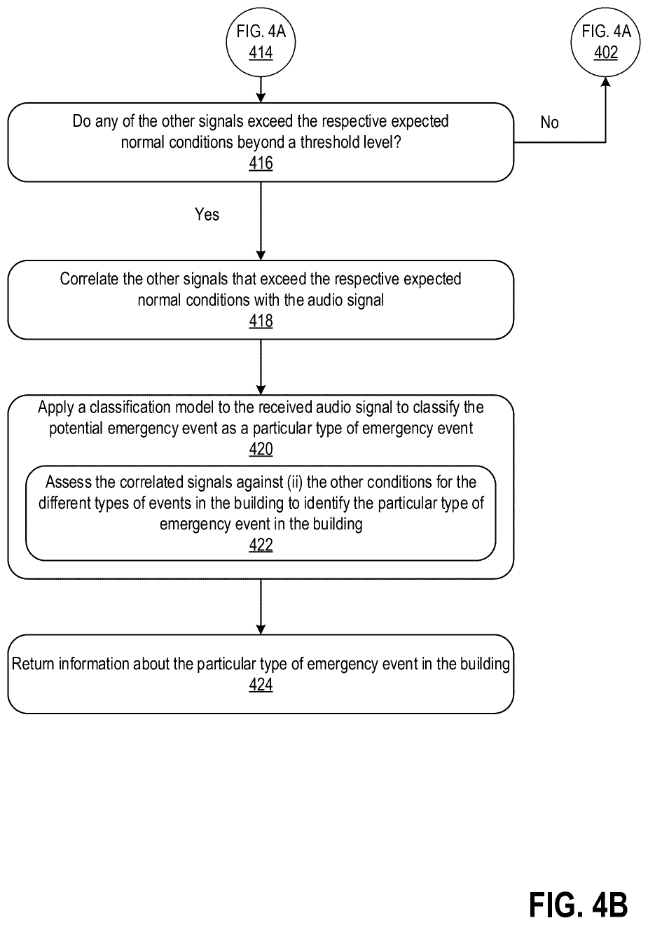

FIGS. 4A and 4B is a flowchart of a process 400 for detecting a particular type of emergency from anomalous signals. The process 400 can be performed to process signals that may not readily be used to discern a particular emergency type in a location such as a building. The illustrative example of the process 400 provides for processing audio signals to detect the emergency. However, the process 400 can also be used to process various other types of signals and/or combinations of signals described herein in order to detect the emergency.

The process 400 can be performed by the edge device 108A described in at least FIG. 1. The process 400 can also be performed by one or more other edge devices, sensor devices, computing systems, devices, computers, networks, cloud-based systems, and/or cloud-based services. For illustrative purposes, the process 400 is described from the perspective of an edge device.

Referring to the process 400 in both FIGS. 4A and 4B, the edge device can receive audio signals from a sensor device in a building (block 402). Refer to at least FIG. 1 for further discussion.

The edge device can retrieve (i) expected normal audio conditions for the building and (ii) other conditions for different types of events in the building in block 404. Refer to at least FIG. 3 for further discussion.

In block 406, the edge device can determine whether the received audio signal deviates from (i) the expected normal audio conditions for the building beyond a threshold level.

If the audio signal does not deviate, the edge device can return to block 402 and continue to passively monitor conditions in the building. After all, the audio signal can deviate from the expected conditions within a threshold range and still be considered normal.

If the audio signal does deviate beyond the threshold level in block 406, then the edge device can identify a potential emergency event in block 408.

The edge device may also ping other sensor/edge devices in the building for signals captured within a threshold amount of time as the audio signal (block 410). The edge device can transmit notifications with timestamps to each of the sensor/edge devices. The notifications can request signals that were captured at the same or similar timestamp as that of the audio signal received in block 402. By requesting signals from other sensor/edge devices, the edge device can correlate signals to determine whether an emergency event in fact occurred. By correlating the signals, the edge device can also more accurately classify the event.

In block 412, the edge device can receive the other signals from the other sensor/edge devices. The other signals can be other audio signals like the one that was received in block 402, except the other signals can be detected in other locations in the building. For example, if the audio signal received in block 402 was detected at a front of the building, then the edge device can receive an audio signal from a sensor device located at a back of the building. The other signals can also be any one or more of light, visuals, temperature, smoke, motion, etc.

The edge device can retrieve expected normal conditions for each of the other signals in block 414. The expected normal conditions can be retrieved as described in reference to block 404. Sometimes, the edge device can retrieve an aggregate expected normal condition for the building that represents a combination of the other signals that are received in block 412.

The edge device may then determine whether any of the other signals exceed the respective expected normal conditions beyond a threshold level in block 416.

If none of the other signals exceed the expected conditions beyond the threshold level, then the edge device can determine that no emergency has been detected. Accordingly, the edge device can return to block 402 to continuously and passively monitor conditions in the building. In other words, the edge device can continue to passively monitor the building via the sensor/edge devices. The edge device can continue to receive anomalous signals from the sensor/edge devices that represent different detected conditions in the building.

On the other hand, if at least one of the other signals exceeds the respective expected conditions beyond the threshold level in block 416, the edge device can correlate the other signals that exceed the respective expected normal conditions with the audio signal (block 418). In other words, the edge deice can confirm or otherwise verify that an emergency event was detected. By linking or correlating the signals that exceed expected normal conditions beyond the threshold level during a same or similar timeframe, the edge device can positively identify the emergency event.

The edge device can apply a classification model to the received audio signal to classify the potential emergency event as a particular type of emergency event (block 420). Refer to FIG. 3 for further discussion about classifying the emergency event. Classifying the emergency can include, for example, assessing the correlated signals against (ii) the other conditions for the different types of events in the building to identify the particular type of emergency event in the building (block 422).

In block 424, the edge device can return information about the particular type of emergency event in the building. Refer to at least FIGS. 1, 2, and 3 for further discussion about returning the information to relevant stakeholders and parties.

FIGS. 5A and 5B is a flowchart of a process 500 for training an AI model to classify emergencies. The process 500 can be performed by the edge device 108A described in at least FIG. 1. The process 500 can also be performed by one or more other edge devices, sensor devices, computing systems, devices, computers, networks, cloud-based systems, and/or cloud-based services. For example, the AI model can be generated and trained by a remote backend computer system. Once the model has been trained and tested/validated, it can be transmitted to/deployed at the edge device 108A for runtime use/execution. For illustrative purposes, the process 500 is described from the perspective of an edge device.

Referring to the process 500 in both FIGS. 5A and 5B, the edge device can receive different types of signals detected in a location in block 502. The signals can include, but are not limited to, audio signals (block 504), visual signals (block 506), pressure signals (block 508), temperature signals (block 510), and/or motion signals (block 512). The signals can be received from sensor devices and/or edge devices described throughout this disclosure. The signals can be received from the sensor devices and/or the edge devices in a particular building, such as the location. The signals can also be received from sensor devices and/or edge devices in other locations and/or buildings. Moreover, the signals can be received for and/or over one or more different time periods.

The edge device can retrieve expected conditions information associated with the location in block 514. The expected conditions information can be retrieved from a data store. Sometimes, the expected conditions information can be the same as or otherwise include the signals received in blocks 502-512.

In block 516, the edge device can determine whether and how the received signals may deviate from the expected conditions information. The edge device can apply one or more rulesets and/or criteria to determine how much the received signals may deviate from the expected conditions information. The edge device can also use statistical analysis and/or AI/machine learning to quantify such deviations and.

Accordingly, the edge device can annotate the received signals with different types of emergencies and based on respective deviation from the expected conditions information (block 518). The annotations can be performed automatically by the edge device. Sometimes, one or more of the annotations can be determined and provided as user input at the edge device or at a user device. The edge device can annotate one or more of the signals (or a combination of the signals) as indicative of an emergency if a deviation of the signals from the expected conditions information exceeds some predetermined threshold value or range. Sometimes, as described herein, the signals may deviate from the expected conditions but may not deviate enough to warrant identification of an emergency. As an illustrative example, a home with a fireplace may not have an active fire during 3 of 4 seasons. During the winter season, smoke sensors may generate signals indicative of higher levels of smoke than during the other seasons. However, because it is more typical to have fires during the winter, the edge device can determine that such a deviation in smoke level signals during the winter is not an emergency. The edge device can annotate the smoke level signals as not indicative of an emergency. Sometimes, the edge device may only annotate the signals that are indicative of emergencies.

In block 520, the edge device can correlate the annotated signals based on the types of emergencies. For example, the edge device can apply one or more rulesets and/or AI/ML techniques to group together annotated signals that indicate same types of emergencies (e.g., audio signals of screams or shouting annotated as a break-in can be grouped together with motion signals of fast movement near entries in the building, which may also be annotated as a break-in).

Optionally, the edge device may generate synthetic training data indicating one or more of the types of emergencies or other types of emergencies (block 522). The synthetic training data can be generated using generative AI techniques. The synthetic training data can include annotated signals, which may represent the types of emergencies that have already been identified from the original annotated signals. The synthetic training data can also include annotated signals that represent new or other types of emergencies that may not have already been identified from the original annotated signals. For example, the original annotated signals may only identify break-ins, water leaks, and fires. The edge device can then generate synthetic training data in block 522 that includes different types of annotated signals that identify active shooter scenarios, gas leaks, and floods. Accordingly, the synthetic training data can be used to enhance the training data used for the model(s) so that the model(s) can accurately detect various different types of emergencies.

The edge device can then train one or more models to classify signals into the different types of emergencies in block 524. For example, the edge device can receive the correlated annotated signals as training inputs (block 526). The edge device can optionally receive the synthetic training data as training inputs (block 528). The edge device can train the model(s) to determine a type of emergency (block 530). The edge device can train the model(s) to determine a severity level of an emergency (block 532). The edge device can train the model(s) to project a spread of the emergency (block 534). The model(s) can be trained in blocks 524-534 to detect and classify different types of emergencies in the particular location/building as well as other locations/buildings. As a result, the model(s) can be easily and efficiently deployed for runtime use at any location.

The edge device can generate and train one or more types of AI and/or machine learning models using the disclosed techniques. As non-limiting examples, the edge device can train a linear regression model, which can be used to discover relationships between different sensor signals that can indicate a type of emergency. The edge device can train a random forest model, which can be used to solve both regression and classification problems. The edge device can train a supervised learning model, which can be configured to take what it previously learned and make predictions/classifications based on various input-output pairs. The edge device can train a reinforcement learning model using a rewards/punishments schema. The edge device can train a decision making model, which can be highly efficient in reaching decisions/conclusions based on data from past decisions. The edge device can train a machine learning model that can self-improve through experience and makes predictions accordingly. The edge device can train a support vector machine, which can analyze limited amounts of data to make classifications and/or regression determinations. The edge device can train a Generative Adversarial Network (GAN) as an advanced deep learning architecture having a generator and a discriminator to make determinations and classifications. Among other illustrative examples, the edge device can train deep learning neural networks and/or other types of neural networks using the disclosed techniques.

Training the model(s) in blocks 524-534 can include applying weighting variables to each of the training inputs, or parameters, in order to generate a mathematical equation. The equation can be training output. The equation can be executed by the trained model(s) during runtime to generate model output (e.g., the model output being classification of an event). The model(s) can be assessed for accuracy based on providing additional training inputs to the equation, and receiving output from execution of the equation, such as a binary value (e.g., true/false). The outputted binary value can be assessed against one or more criteria to determine whether the equation is working as expected (e.g., performing at or above a predetermined threshold level of accuracy).

The training inputs (e.g., parameters) described above can include, but are not limited to, temperature, sound levels, pressure levels, movement, and/or time. The weighting variables can be identified uniquely for each of the training inputs. An illustrative example of the equation may include: (temperature*X)*(movement*Y)*(time*Z). Various other equations may also be generated as training output to be executed by the trained model(s) in classifying events during runtime. During runtime, the equation can be performed to classify an event, as described herein, which can be based on at least one of (i) the parameters and/or the weighting variables that are derived from use of the trained model(s) and (ii) runtime sensor signals/signal data (e.g., real-time or near real-time temperature signals, pressure signals, movement signals, audio/sound signals).

The edge device can return the trained model(s) in block 536. The model(s) can be returned once the edge device determines that the model(s) accuracy achieves some predetermined threshold level of accuracy. If the threshold level of accuracy is not achieved, the edge device can iteratively train and retrain the model(s) on the training data until the threshold level of accuracy can be achieved. Returning the model(s) can include deploying the model(s) on the edge, such as at any of the edge devices described herein. Sometimes, returning the model(s) can include deploying the model(s) on the cloud, to be used for additional processing during runtime use.

In block 538, the edge device can optionally iteratively improve the model(s) based on results during runtime use. For example, during the runtime use, the edge device can receive user feedback, inputs, and/or sensor signals, which can be used to retrain the model(s). Such retraining inputs can include, but are not limited to, user input indicating false alarms or that an emergency does not in fact exist, sensor signals indicating movement of the users at the location during the emergency, sensor signals indication actions taken by the users in response to the emergency, information from emergency responders indicating their actions and/or movements taken in response to the emergency.

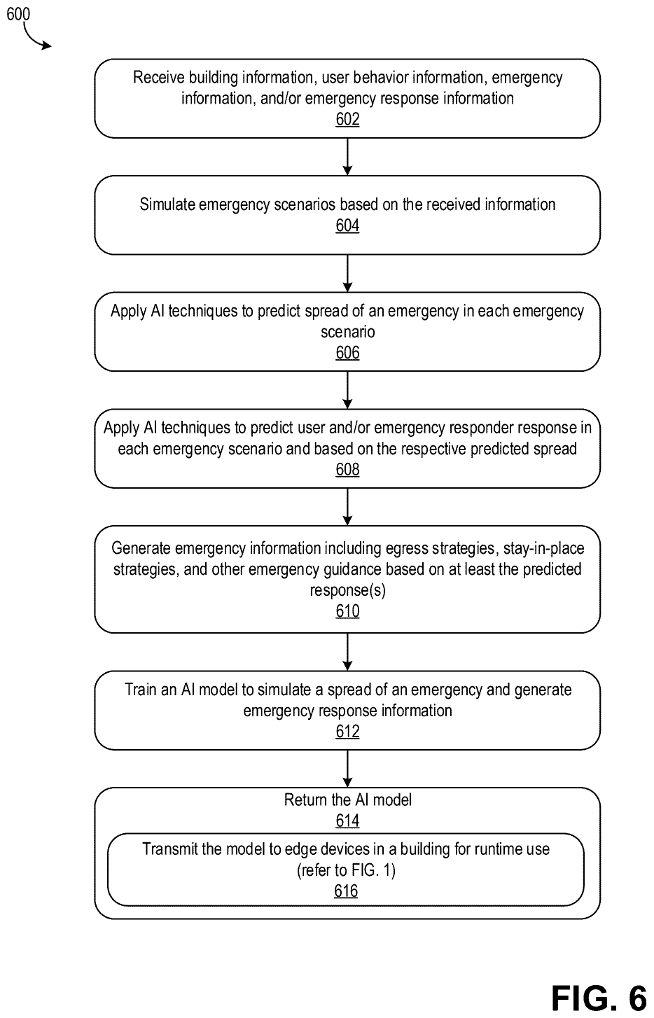

FIG. 6 is a flowchart of a process 600 for training a model to detect an emergency and a respective response strategy. The model can then be used to perform one or more operations described herein, such as in reference to FIG. 1. The process 600 can be performed by the edge device 108A described in at least FIG. 1. The process 600 can also be performed by one or more other edge devices, sensor devices, computing systems, devices, computers, networks, cloud-based systems, and/or cloud-based services. For example, the process 600 can be performed by a remote backend computer system, which can then deploy the trained model to the edge device 108A or other devices/computing systems described herein. For illustrative purposes, the process 600 is described from the perspective of an edge device.

Referring to the process 600, the edge device can receive building information (e.g., building layout, structural information, number of egresses, sprinkler systems, fire systems, security systems), user behavior information (e.g., user demographics, user age(s), user physical ability characteristics, user disabilities, user type such as a resident or visitor), emergency information (e.g., real-time or previously detected emergencies, types of emergencies, emergency spreads, emergency severity), and/or emergency response information (e.g., engaged emergency responders, response actions of users, response actions of emergency responders) in block 602. Any of this received information can include the training information described in reference to the process 500 of FIGS. 5A and 5B. This received information can be collected by sensor and/or edge devices described herein in one or more locations such as buildings. At least a portion of this information can be generated by the edge device or other computer systems described herein based on processing the information (e.g., signals) collected by the sensor/edge devices.

In block 604, the edge device can simulate emergency scenarios based on the received information. The edge device can use machine learning and/or AI techniques to flesh out potential safety vulnerabilities and determine appropriate response strategies for each of the simulated scenarios. The edge device can simulate different emergency scenarios to determine how quickly the emergency can spread to other areas, spaces, and/or floors and how the spread of the emergency may impact the users and/or the structure of the building. Any of the received information may be processed by the edge device and using the machine learning/AI to simulate many possible emergency scenarios.

The edge device can also apply AI techniques to predict a spread of an emergency in each emergency scenario (block 606). Refer to block 604 for further discussion about predicting the spread of the emergency. In brief, the received information can be modeled and annotated to identify how previous emergencies have spread or are likely to spread in previous buildings, locations, and/or the simulated emergency scenarios. The edge device can then train a model described herein to predict a spread of any type of emergency based on the modeled and annotated emergencies and/or simulations. The model can be trained, for example, to predict whether and/or how quickly a fire may spread from one starting point in a building to other locations in the building. As another example, the model can be trained to predict how a water leak can spread through a water system and/or throughout the building. As yet another example, the model can be trained to predict how an active shooter may move through a location such as a building to attack users at the location.

The edge device can apply AI techniques to predict user and/or emergency responder response in each emergency scenario and based on the respective predicted spread in block 608. For example, the edge device may model how well users may egress, stay in place, or follow other emergency response instructions during any of the simulated emergency scenarios. The edge device can model how users may respond to predicted response strategies in any of the simulated scenarios.

In reference to blocks 604, 606, and 608, the edge device may use a specialized time temperature equation that is mathematically deterministic, incorporated with stochastic analysis for added rigor and safety. The power of predictive analytics lies in its ability to predict, as an illustrative example, the rate of rise of temperature in a space that contains a fire, starting from fire initiation to maximum growth before ultimate decline. As its primary goal, the methodology utilized by the edge device can predict times to maximum escape temperature and flashover. These parameters, coupled with other received information versus mobility and general physical and mental capabilities of users in a building, can allow for the edge device to predict and establish the viability of emergency response strategies.

In block 610, the edge device can generate emergency response information including egress strategies, stay-in-place orders, and other emergency guidance based on at least the predicted response(s). The edge device may create, audio, visual, haptic, AR/VR, and/or hologram signaling instructions that can be provided to users during real-time emergencies to assist the users in reaching safety.

The edge device can then train an AI model to simulate a spread of an emergency and generate emergency response information (block 612). In other words, the AI model can be trained based on performing blocks 604-610. The model can be trained to predict how any type of detected emergency may spread at a location, how users at the location may respond, and what type of response strategies and/or instructions can be provided to the users at the location. The model can be trained similarly as described in the process 500 of FIGS. 5A and 5B. In some implementations, the operations described in the process 600 of FIG. 6 can be performed as part of the process 500 of FIGS. 5A and 5B to train models for runtime use.

The trained AI model can be returned in block 614. For example, the model can be transmitted to edge devices in a building or other location for runtime use (block 616). Refer to FIG. 1 for further discussion about runtime use.

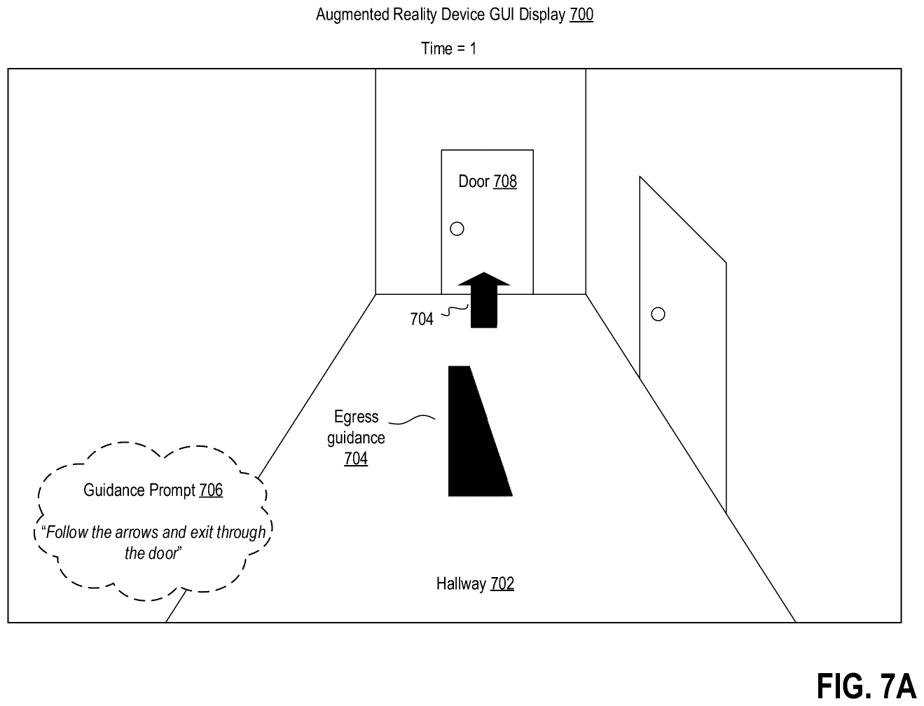

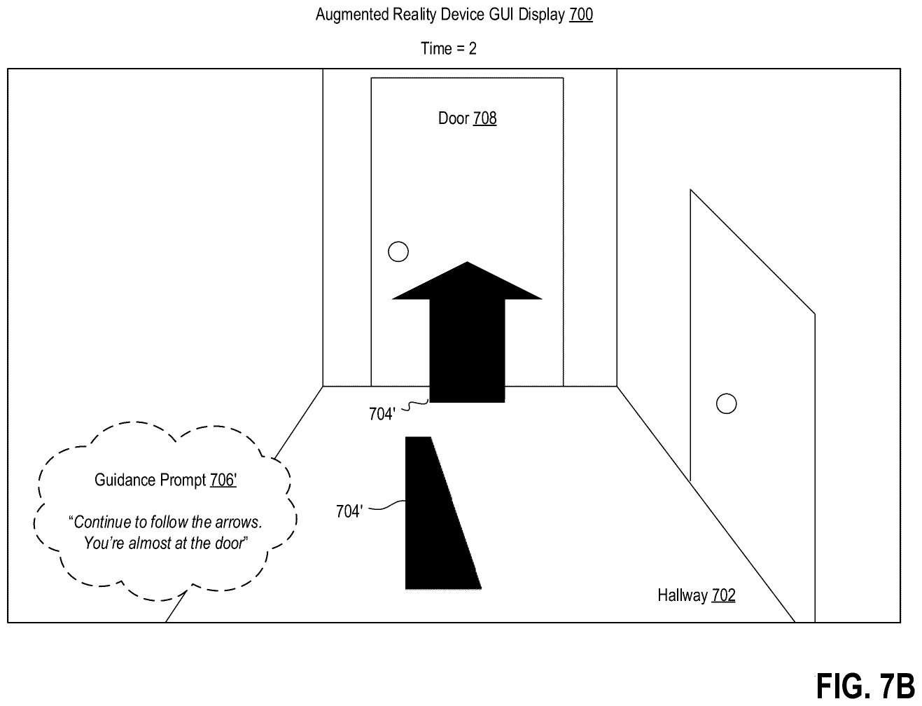

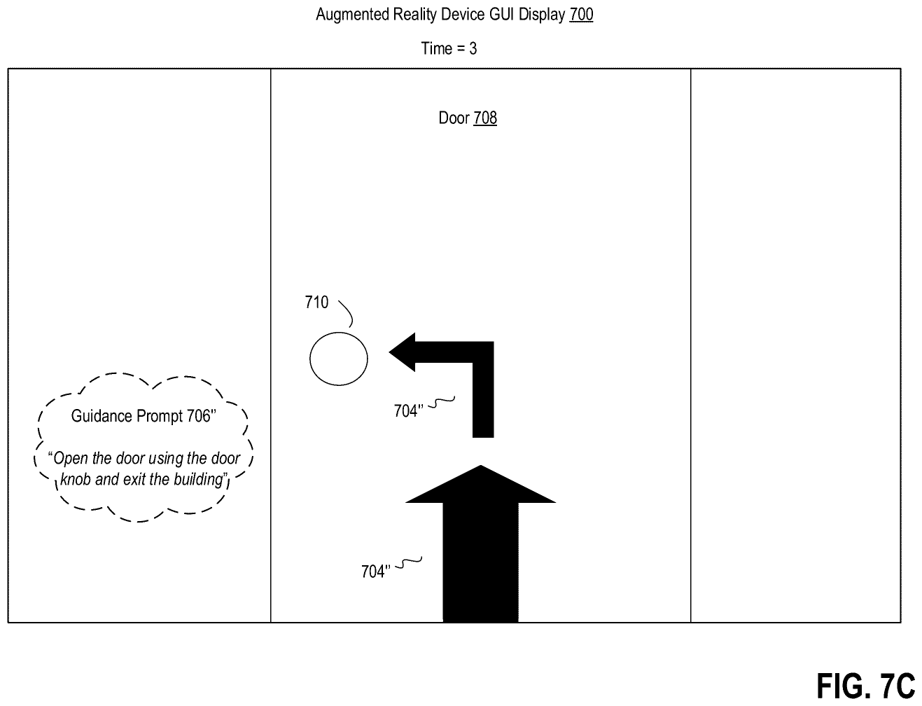

FIGS. 7A, 7B, and 7C depict illustrative guidance presented using AR during an emergency. Egress guidance can be provided to users in a building, such as building occupants and/or emergency responders, using AR/VR. AR can assist the user in understanding where they should go or what they should do during the emergency, such as seeking a place of safety or staying in place. With AR, egress guidance, such as instructions and directions, can appear to be projected onto an environment that the user is currently located within, making it easier and less stressful for the user to understand what to do. The user can put on an AR device, such as a headset, glasses, goggles, or dongle that attaches to the user's head. The egress guidance can be projected in a graphical user interface (GUI) display 700 of the AR device. Thus, the egress guidance can appear in front of the user as the user is moving through the environment. In some implementations, the egress guidance can be provided at a mobile device of the user and/or a wearable device. Such device can be configured to project the egress guidance into the environment that the user is currently located within. In some implementations, the user can hold up their device in front of them and turn on a camera feature of their device. A live preview of what is captured by the camera can be outputted on a display screen of the user's device, and the egress guidance can be presented as overlaying the live preview. As a result, the user can view the egress guidance in the environment that they are currently moving through.

The egress guidance via AR, as described in reference to FIGS. 7A, 7B, and 7C, can also be applied to emergency simulations and emergency training, described further below. The user can then practice the egress guidance before an emergency to become comfortable with how they may be required to respond to a real-time emergency. Refer to U.S. application Ser. No. 17/352,968, entitled “Systems and Methods for Machine Learning-Based Emergency Egress and Advisement,” with a priority date of Mar. 1, 2021 for further discussion, the disclosure of which is incorporated herein by reference in its entirety.

Referring to the figures, FIG. 7A depicts emergency guidance 704 presented in the GUI display 700 at time=1. At time=1 in FIG. 7A, an emergency may be detected and the emergency guidance 704 can overlay portions of the environment where the user is currently located. The emergency guidance 704 can be presented in the form of visual depictions and/or graphical elements that visually and easily direct the user on how they should respond. In the example of FIG. 7A, the emergency guidance 704 includes arrows, clearly indicating a direction at which the user should move to reach safety.

In this example, the user is in hallway 702. The egress guidance 704 includes arrows that are projected onto a floor of the hallway 702 and part of a door 708. The egress guidance 704 therefore visually instructs the user to move down the hallway 702 and exit through the door 708. Moreover, a guidance prompt 706 can overlay a portion of the display 700. The guidance prompt 706 can include textual instructions to help guide the user towards the exit. In this example, the guidance prompt 706 says, “Follow the arrows and exit through the door.” Various other guidance prompts can be presented to the user. The guidance prompts can depend on assessment of the particular user and/or the particular emergency. As described herein, an edge device can use AI techniques to detect the emergency, project the spread of the emergency, how each user near the emergency may respond, and what information/guidance to present to the user to help them respond to the emergency. Output from applying the AI techniques may include the guidance prompts depicted and described herein.

FIG. 7B depicts emergency guidance 704′ presented in the display 700 at time=2. At time=2, the user has moved closer to the door 708. As a result of the user's movement, the guidance 704′ arrows appear larger as the arrows overlay the floor of the hallway 702 and the door 708 at the end of the hallway 702. The guidance prompt 706′ has also been automatically updated based on assessment of current conditions by the edge device described herein. The prompt 706′ can say, “Continue to follow the arrows. You're almost at the door.” As mentioned, the prompt 706′ can vary based on the edge device's real-time assessment of the current conditions, including but not limited to the user response to the prompt 706 and/or guidance 704 described in FIG. 7A.

As shown in FIG. 7B, the guidance 704′ arrows can appear larger as the user moves in the correct direction and/or approaches an appropriate exit. Such automatic changes in visualization can assist the user to calmly reach safety.

FIG. 7C depicts emergency guidance 704″ presented in the display 700 at time=3. At time=3, the user has approached the door 708. The user can be standing in front of the door 708. The emergency guidance 704″ now includes large arrows projected on the door 708 (whereas earlier, as shown in FIGS. 7A and/or 7B, the emergency guidance was shown as projecting on the floor of the hallway 702 leading up to the door 708). The guidance 704″ also can be directed towards a door knob 710, thereby visually instructing the user to turn the knob 710 to open the door 708 and exit. Guidance prompt 706″ may be automatically updated to say, “Open the door using the door knob and exit the building.” The guidance prompt 706″ can be automatically updated according to the edge device's real-time assessment of the user response to the emergency and the current conditions of the emergency.

As shown in FIGS. 7A, 7B, and 7C, the emergency guidance can be updated in real-time, by the edge device described herein, to reflect movement of the user in the environment, the user's response to the detected emergency, and the current conditions of the emergency (e.g., a spread of the emergency). For example, as the user moves in real-time towards the door 708, the emergency guidance arrows can progressively expand into larger egress guidance arrows. Moreover, as shown in reference to FIG. 7C, additional egress guidance arrows can populate the display 700 when the user approaches the door 708 or other portions of the environment when the user may be required to take some action (e.g., open the door 708 by turning the door knob 710, open a window by unlocking a hatch on the window, etc.). The additional visual guidance and/or prompts can help the user to calmly find their way to safety during the emergency. Moreover, the egress guidance arrows and other projected egress guidance can be semi-translucent/transparent so that the user can see the surrounding environment through the projected egress guidance. Accordingly, the egress guidance may be presented in the display 700 to guide the user without distracting the user from focusing on the environment and a quick and safe egress.

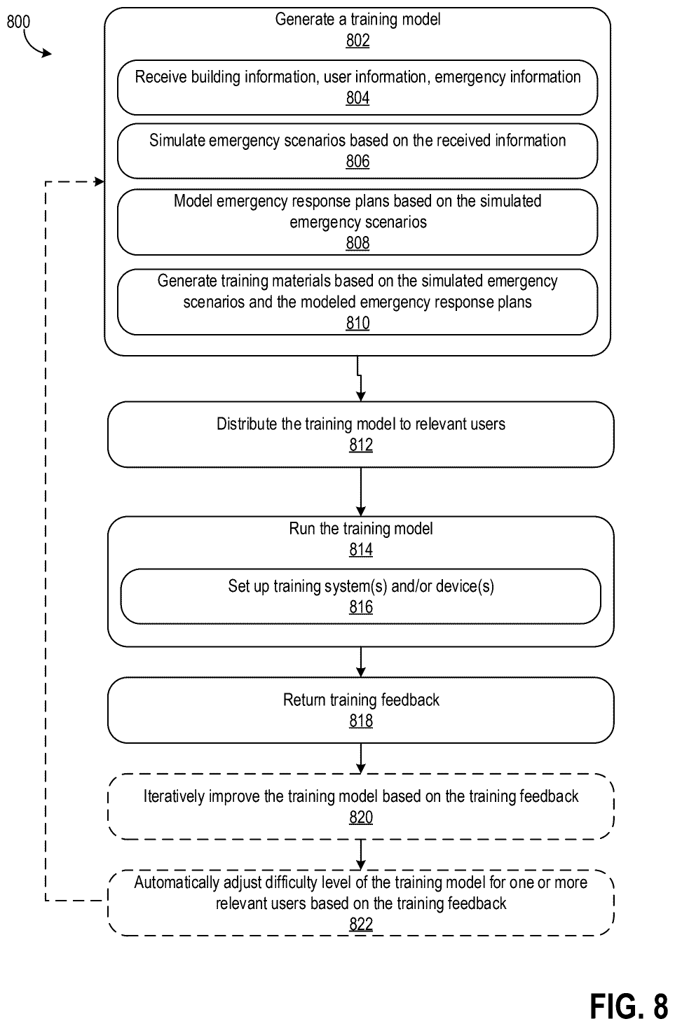

FIG. 8 is a flowchart of a process 800 for generating and implementing a training simulation model. The training simulation model can be used by relevant users, such as building occupants and/or emergency responders to learn and practice how to respond to different types of emergencies. As a result, in the event of a real-time emergency, the relevant users can be comfortable and less stressed/anxious in responding to the emergency and following emergency guidance/instructions.

The process 800 can be performed by the edge device 108A described in at least FIG. 1. The process 800 can also be performed by one or more other edge devices, sensor devices, computing systems, devices, computers, networks, cloud-based systems, and/or cloud-based services. For example, the process 800 can be performed by a remote backend computer system. Once the remote backend computer system generates the training simulation model, the system can transmit the model to other devices, such as the edge device 108A or computing devices of one or more relevant users (e.g., building occupants, emergency responders). For illustrative purposes, the process 800 is described from the perspective of a computer system.

Referring to the process 800 in FIG. 8, the computer system can generate a training model in block 802. Generating the training model can include receiving building information, user information, and/or emergency information (block 804). Any of this information can be retrieved from a data store and/or computing systems of relevant users (e.g., building occupants, building managers, emergency responders). In brief, the building information may include a building layout, structural information, and/or information about fire suppression, water supply, gas, security, and/or other systems that may be part of the building. The user information may include age, demographic, physical attributes, and/or other information about users associated with the building. The emergency information may be associated with past-identified emergencies at the building or other buildings, including but not limited to types of emergencies, spreads of the emergencies, user responses to the emergencies, emergency responder actions based on the emergencies, damage to the building, etc.

The computer system can simulate emergency scenarios based on the received information (block 806). Refer to the process 600 in FIG. 6 for additional discussion about simulating the emergency scenarios.

In addition, the computer system can model one or more emergency response plans based on the simulated emergency scenarios (block 808). The computer system can apply one or more AI and/or machine learning techniques described herein to model the emergency response plans for each of the simulated emergency scenarios. The emergency response plans can include instructions that may be outputted to the building occupants and/or the emergency responders for assistance in safely responding to the simulated emergency scenarios. As an illustrative example, the emergency response plans can be generated for building occupants or emergency responders who are going to undergo the generated training model. Rescue plans can be generated for emergency responders who are going to undergo the generated training model.

The computer system can then generate training materials based on the simulated emergency scenarios and the modeled emergency response plans (block 810). Those training materials can include the training model described herein. The training models can be generated of different emergency scenarios in different types of buildings, including but not limited to fires, water or gas leaks, active shooters, etc. Generating the training materials may include integrating AR, VR, MR, and/or XR into the training model such that trainees can experience (e.g., walk through) any particular emergency and response plan. As an illustrative example, the computer system can generate a VR replication of a particular building as part of the training material(s). A trainee would then go into this VR replication, receive one of the modeled emergency response plan(s), which can include instructions about how to egress from the VR replication of the building in one or more different emergency scenarios, and follow the plan to reach safety in the VR replication of the building

Once the training model is generated, the computer system can distribute the training model to relevant users (block 812). For example, the computer system can transmit the training model and/or instructions for execution to computing devices of the relevant users.

The training model can be run at the computing devices of the relevant users in block 814. Running the training model may include setting up a training system and/or devices accordingly (block 816). For example, the simulation training model can be installed on a VR headset. A smartwatch and/or heartrate monitor can be attached to a trainee who is wearing the VR headset. The smartwatch and/or heartrate monitor can be configured to be in communication with the VR headset and/or the system described herein such that real-time biometric conditions of the trainee can be collected as the trainee undergoes the training simulation. In some implementations, the simulation training model can be installed at a mobile device, such as a smartphone, or a building occupant or emergency responder. A network connection between the mobile device and one or more biometric sensors may also be established such that biometric conditions of the trainee (e.g., heartrate, sweat levels) can be tracked and analyzed while the trainee undergoes the training.

Training feedback can be returned in block 818, in response to running the training model at the computing devices. The feedback can include biometric data about the trainee while the trainee undergoes training simulation. The feedback may also include an amount of time that the trainee took to undergo the training simulation. The received training feedback can be used by the computer system to improve the training model, determine and/or generate different emergency response plans for the trainee, update emergency response strategies and/or instructions that may be used during a real-time emergency, and/or generate information about the trainee to determine how they may respond to a real-time emergency.

Optionally, the computer system can iteratively improve the training model based on the training feedback (block 820). The training model can be improved to appear more realistic or similar to what the relevant users may experience during a real-time emergency. Improving the model may include adjusting or changing how emergency response instructions may be presented to a particular trainee. For example, the particular trainee can provide feedback indicating that they prefer receiving voice commands during a fire emergency but text notifications/alerts during an active-shooter emergency. The computer system can process this feedback to improve the training model's emergency response output for the particular trainee.

Optionally, the computer system can additionally or alternatively automatically adjust a difficulty level of the training model for one or more relevant users based on the training feedback (block 822). As described above, the training model can be adjusted based on the trainee's performance during the simulation. If, for example, the trainee easily completed the simulation without raising their heartrate or other signs of stress or discomfort during the simulation, the computer system may determine that the simulation was relatively easy for the trainee. As a result, the computer system may adjust the training model to be more challenging for the trainee to complete (e.g., adding in challenges such as assisting another user in the building, increasing a speed at which an emergency spreads through the building, reducing an amount of possible egress routes that may be taken, adding additional emergencies into the simulation). The adjusted model can then be provided to relevant computing devices for execution.

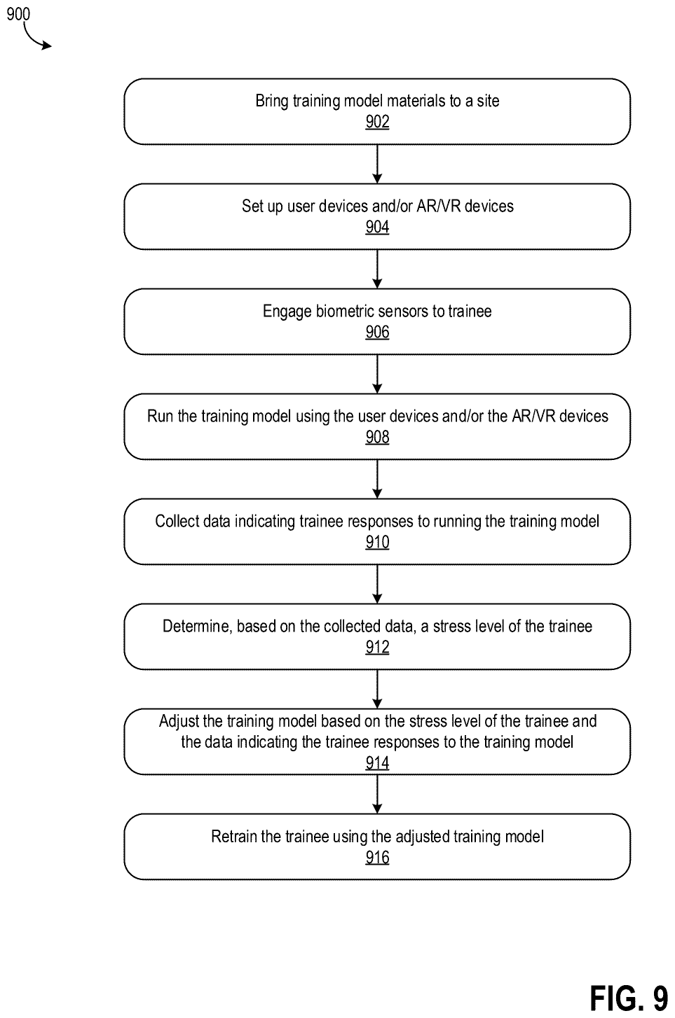

FIG. 9 is a flowchart of a process 900 for implementing and improving a training simulation model. The process 900 can be performed in response to one or more operations performed and described in the process 800 of FIG. 8. For example, the process 900 can be performed once the training simulation model (e.g., the training model) has been generated and run according to the process 800 of FIG. 8. The process 900 may include one or more operations that can be performed when running the training model. The process 900 may also include one or more additional operations that can be performed in response to running the training model.

The process 900 can be performed by one or more users and/or computing systems/devices, such as the edge device 108A described in at least FIG. 1. The process 900 can also be performed by one or more other edge devices, sensor devices, computing systems, devices, computers, networks, cloud-based systems, and/or cloud-based services. For example, one or more blocks in the process 900 can be performed by a remote backend computer system.

Referring to the process 900 of FIG. 1, training model materials can be brought to a site in block 902. The site can be a building where building occupants may undergo safety training. In some implementations, the site can be a firehouse or other location where emergency responders undergo safety training. The training materials can be communicated, via a network, to one or more computing devices that are used to train the users described herein. For example, a building occupant can undergo the training model described herein at home, using their smartphone.

User devices and/or AR/VR devices can be set up in block 904. Setting up the device can include installing, executing, running, and/or uploading the training model to the devices.

In block 906, biometric sensors may be engaged to a trainee. The biometric sensors may include wearable devices, such as headphones, watches, glasses, rings, and/or heartrate monitors.

The training model can then be run using the user devices and/or the AR/VR devices (block 908). In other words, the trainee can begin the training model.

Data indicating trainee responses to running the training model can be collected (block 910). The biometric sensors may collect biometric data while the trainee is undergoing the simulation. The user devices and/or the AR/VR devices may also collect user performance data while underdoing the simulation. The data can be transmitted to a computer system described herein, such as an edge device and/or a remote backend computer system. This data can be used by the computer system to analyze how well the trainee performed during the simulation, whether improvements can or should be made to the training model, and what types of emergency response information/instructions should be provided to users during a real-time emergency.

For example, a stress level of the trainee can be determined, based on the collected data, in block 912. Block 912 can be performed by the remote backend computer system and/or any other device described herein, such as an edge device. The remote backend computer system can, for example, apply one or more AI and/or machine learning techniques to the collected data to determine the trainee's performance information, such as whether the trainee experienced levels of stress while undergoing the simulation, whether the trainee was relaxed, whether the trainee panicked, whether the trainee began to sweat or sweat more during the simulation, whether the trainee's heartrate increased during the simulation, etc. The remote backend computer system can generate a numeric or integer value indicating the trainee's stress level. The determined stress level can be used by at least the remote backend computer system to determine whether to improve the training model and/or adjust training/emergency response information for the particular trainee. The trainee's stress level may also be critical to determine whether the trainee should undergo additional training models, whether the trainee needs to receive different instructions, and/or whether the trainee would need help from other occupants emergency responders to reach safety during an emergency.

The training model can be automatically adjusted based on the stress level of the trainee and/or the data indicating the trainee responses to running the training model (block 914). For example, the training model can be adjusted to get harder if the trainee excels through the training model. As another example, the training model may be adjusted to be easier if the trainee struggled with the training model or increases in stress or discomfort when undergoing the simulation. Block 914 can be performed by the remote backend computer system and/or any other device described herein, such as an edge device. Refer to FIG. 8 for further discussion about adjusting the training model based on the trainee's stress level and/or overall performance during the simulation. As described herein, the remote backend computer system may leverage AI techniques and/or machine learning models to generate the training model and to also assess the trainee performance and dynamically adjust the training model.

In block 916, the trainee may be retrained using the adjusted training model. For example, once the training model has been adjusted, the remote backend computer system can transmit, over a network connection, the adjusted model to a computing device of the relevant trainee. The computing device can execute or otherwise run the adjusted model so that the trainee may undergo a new training simulation.

In some implementations, one or more operations in the process 900 can be performed while emergency responders are on-route to a location having an emergency. For example, the emergency responders can include firefighters. As the firefighters are being driven to a burning building, the remote backend computer system can transmit a fire emergency training simulation model to computing devices of the firefighters. The computing devices of the firefighters may execute the fire emergency training simulation model to educate the firefighters about what to expect at the building once they arrive. This model can, for example, simulate the actual fire in its starting location in the building and show how the fire may spread throughout the rest of the building. The model can additionally or alternatively provide instructions indicating how the fire fighters may enter the building and assist users inside the building. As a result, the firefighters can practice, virtually and using their respective computing devices, an emergency response plan so that when they arrive at the burning building, they are calm, collected, and ready to efficiently and safely respond to the emergency.

Although one or more operations in the process 900 are described from the perspective of training emergency responders, the process 900 may also be performed to train building occupants and other users, such as students in schools and/or medical professionals in hospitals.

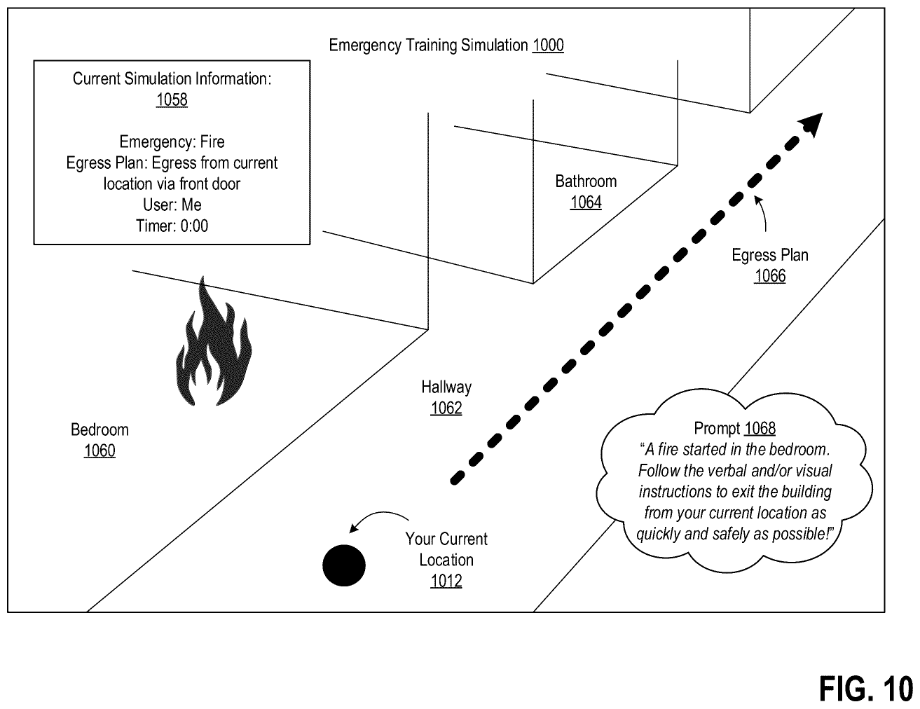

FIG. 10 is an illustrative GUI display of an emergency training simulation 1000 for a user. The user can be any relevant stakeholder described herein, such as an emergency responders and/or a building occupant. The simulation 1000 can provide a simulation of any type of emergency scenario that may arise at a location associated with the user. The simulation 1000 can be presented in one or more GUIs of the user's device, such as a mobile device or smartphone. As another example, the simulation 1000 can be presented as visually overlaying lens of AR/VR glasses and/or helmets of the user.

In the simulation 1000, at time 0:00, a current location 1012 of the user is depicted in in hallway 1062. The current location 1012 can be an actual current location of the user in the building. The current location 1012 can be a simulated location of the user in a simulation, regardless of where the user is currently located. For example, the current location 1012 can be a most frequented room associated with the user (e.g., a master bedroom) but at the time that that the user is engaging with the simulation 1000, the actual current location of the user may be different.

In the simulation 1000, a fire can be simulated in bedroom 1060. Current simulation information 1058 may be presented to the user in the simulation 1000. The current simulation information 1058 can indicate what type of emergency is being simulated, what egress plan the user must follow, who is undergoing the simulation 1000, and a timer indicating how long it takes the user to complete the simulation.

An egress plan 1066 visually overlays the hallway 1062 in the simulation 1000. The plan 1066 indicates which direction the user must go in in order to reach safety. The plan 1066 can be presented to the user in a number of different ways to mimic or replicate how the plan 1066 would be presented to the user during a real-time emergency. For example, if egress devices in the building are configured to emit light signals that illuminate an egress plan for the user, then in the simulation 1000, the egress plan 1066 can be depicted by emitting light signals in the hallway 1062. As another example, if egress devices in the building are configured to emit audio signals instructing the user on how to exit, then in the simulation 1000, the egress plan 1066 can be verbally communicated to the user via output devices of the user's device presenting the simulation 1000.

As yet another example, if the user receives emergency response information as textual prompts at the user's computing device during a real-time emergency (or to test whether the textual prompts would help the user during a real-time emergency), then prompt 1068 can be visually depicted in the simulation 1000. Here, the prompt 1068 notifies the user that “A fire started in the bedroom. Follow the verbal and/or visual instructions to exit the building from your current location as quickly and safely as possible!” The prompt 1068 can be updated in real-time and based on user performance in the simulation 1000. Various other instructions may also be generated and/or dynamically updated based on a particular user, a particular emergency scenario, and/or user responses to the emergency.

In some implementations, a computing system, such as a remote backend computer system and/or an edge device as described herein, can learn and train, using AI and/or machine learning, on data about the user to determine how much and what information to provide the user via the prompt 1068 and/or the egress plan 1066. As an illustrative example, if the user quickly completes the simulation 1000 with minimal or no mistakes, then the computing system can determine the user does not need step-by-step detailed instructions to egress the building during this particular type of emergency. On the other hand, if the user completes the simulation 1000 more slowly and/or makes mistakes, the computing system can learn that the user needs more detailed step-by-step instructions to improve the user's ability to quickly and safely egress. Therefore, the computing system can develop more personalized prompts for the user and based on their performance. Such prompts can be saved and/or used by the computing system when determining what guidance to provide the user during a real-time emergency. For example, during the real-time emergency, the user can receive the same or similar prompts or instructions that the user received during the simulation 1000. Receiving the same prompts or instructions can be beneficial to make the user more comfortable, calm, and relaxed when exiting the building.

To move within the simulation 1000, the user can move from the current location 1012 using gaming techniques, such as swiping or sliding a finger up, down, left, and right on a touchscreen, selecting keys on a keyboard, maneuvering, hovering, and clicking with a mouse, making movements while using AR/VR devices, tilting the user computing device in different directions, maneuvering a joystick, or using other similar gaming devices and techniques. Information presented in the simulation 1000, such as the egress plan 1066, a spread of the fire, the prompt 1068, and/or the current simulation information 1058 can by dynamically and automatically updated. Such updates can be made by the edge device and/or the computing system(s) described herein. In some implementations, the dynamic and automatic updates can be generated by the user's device.

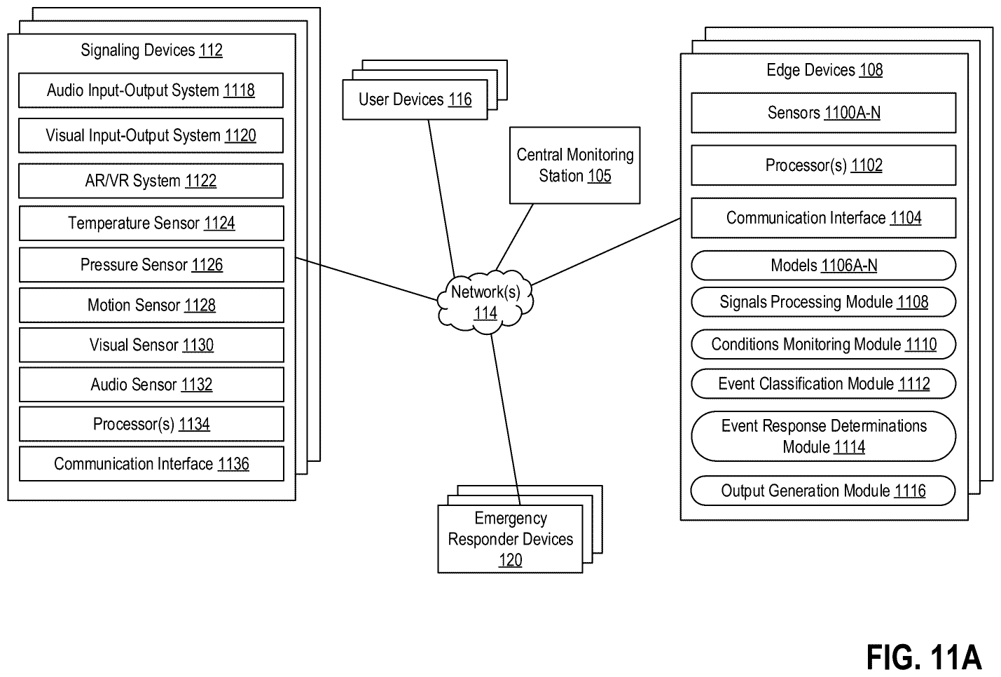

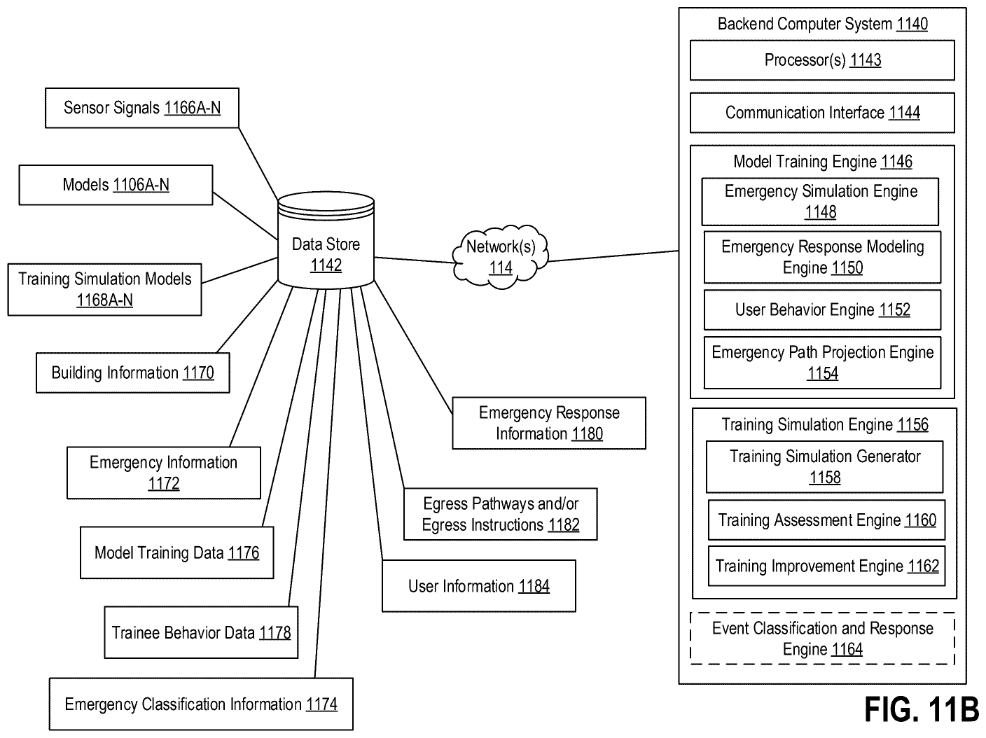

FIGS. 11A and 11B are a system diagram of one or more components that can be used to perform the disclosed techniques. Referring to both FIGS. 11A and 11B, the edge device(s) 108, the signaling device(s) 112, the user device(s) 116, the emergency responder device(s) 120, the central monitoring station 105, a backend computer system 1140 and/or a data store 1142 may communicate with each other (e.g., wired, wirelessly) via the network(s) 114.

The edge device(s) 108 can each include sensors 1100A-N, processor(s) 1102, a communication interface 1104, models 1106A-N, a signals processing module 1108, a conditions monitoring module 1110, an event classification module 1112, an event response determinations module 1114, and/or an output generation module 1116. In brief, the sensors 1100A-N may include any of the sensor devices described herein, including but not limited to temperature, pressure, motion, humidity, image, video, and/or audio sensors. The sensors 1100A-N can be configured to generate sensor signals indicating conditions existing in a location such as a building having the edge device(s) 108 installed therein. The processor(s) 1102 can be configured to locally execute instructions to perform one or more operations described throughout this disclosure. The communication interface 1104 can be configured to provide communication between and amongst components of the edge device(s) 108 and other system components described herein via the network(s) 114.

The models 1106A-N described herein can be stored locally at the edge device(s) 108 so that the models 1106A-N can be quickly accessed for efficient runtime use. The models 1106A-N, described throughout this document, may include AI and/or machine learning models that are trained (by the edge device(s) 108 and/or the backend computer system 1140) to generate output such as emergency detection, emergency classification, emergency spread, emergency response, etc. In some implementations, the models 1106A-N may be stored in the data store 1142 and accessed by at least the edge device(s) 108 during runtime use.

The signals processing module 1108 can be configured to process any of the signals generated by the sensors 1100A-N and/or the signaling device(s) 112. Any of these signals may also be stored in the data store as sensor signals 1166A-N and retrieved by the module 1108 for processing. Processing the signals may include correlating one or more of the signals and/or determining whether one or more of the signals satisfy or exceed respective predetermined threshold levels.

The conditions monitoring module 1110 can be configured to receive the processed signals from the module 1108 (or retrieve the signals 1166A-N from the data store 1142) and determine whether the signals satisfy or exceed respective predetermined threshold levels. The module 1110 can apply one or more of the models 1106A-N to determine whether the predetermined threshold levels are met and/or whether the signals may indicate presence of an emergency at the location of the edge device(s) 108.

The event classification module 1112 can be configured to receive the signals and/or the determination from the conditions monitoring module 1110 and further classify a detected emergency event. The module 1112 may apply one or more of the models 1106A-N to determine a type of the emergency, a severity of the emergency, and/or a projected spread of the emergency. In some implementations, the module 1112 may retrieve building information 1170, emergency information 1172, emergency classification information 1174, emergency response information 1176, egress pathways and/or egress instructions 1182, and/or user information 1184 from the data store 1142. Any of the retrieved information may be used as additional input signals to the models 1106A-N at the classification module 1112 in order to accurately and quickly classify the detected emergency event.

The event response determinations module 1114 may receive output from the event classification module 1112 and can be configured to determine and/or generate emergency response information. Such information may include instructions to notify emergency responders at their device(s) 120 about the emergency. Such information may include instructions to assist relevant users in reaching safety at the location of the emergency. This information may be transmitted to the user device(s) 116 and/or the signaling device(s) 112.

The output generation module 1116 can be configured to receive the emergency response information from the event response determinations module 1114 and generate respective output. The output may then be transmitted to the emergency responder device(s) 120, the user device(s) 116, and/or the signaling device(s) 112 as described herein.

Any of the determinations and/or information generated by components of the edge device(s) 108 may be stored in the data store 1142 and/or transmitted to the backend computer system 1140 for additional processing (e., generating, training, and/or improving the models 1106A-N). For example, the determinations and/or information may be stored in the data store 1142 as the sensor signals 1166A-N, the building information 1170, the emergency information 1172, model training data 1176, the emergency classification information 1174, the emergency response information 1180, the egress pathways and/or egress instructions 1182, and/or the user information 1184. In addition, the components of the edge device(s) 108 may continuously and/or iteratively update their determinations and/or generated information in order to provide updated and real-time information to the relevant users (e.g., building occupants, emergency responders). Such updates can be made based on changes in the emergency (e.g., the spread of the emergency), how the relevant users respond to the emergency and/or emergency response information that is provided to them, etc.

The signaling device(s) 112 can include an audio input-output system 1118, a visual input-output system 1120, an AR/VR system 1122, a temperature sensor 1124, a pressure sensor 1126, a motion sensor 1128, a visual sensor 1130, an audio sensor 1132, processor(s) 1134, and/or a communication interface 1136. In brief, the processor(s) 1134 can be configured to receive instructions from the edge device(s) 108 and/or the backend computer system 1140 for execution. The instructions may include the output generated by the output generation module 1116, such as visual and/or audio instructions to assist the relevant uses proximate the signaling device(s) 112 to reach safety during a real-time emergency.

The audio input-output system 1118 can be configured to receive or detect audio signals and output audio signals. For example, the system 1118 can include a speaker to output sounds, such as audible cues, horns, or verbal messages for emergency response (as generated and provided by the edge device(s) 108). Audio signals detected by the system 1118 can be transmitted to the edge device(s) 108 and/or the backend computer system 1140 for additional processing, as described herein.

The visual input-output system 1120 can be configured to receive or detect visual signals (e.g., images, videos) and output visual signals. For example, the system 1120 can include a display device to display visual signs that guide a user along a selected egress route or to follow other emergency response plans/information. In some implementations, the display device can include a display screen to visually output information with visual signs thereon. In addition or alternatively, the system 1120 may include a projector configured to project a lighted sign on another object, such as a wall, a floor, or a ceiling, or any other visual indications into the location of the user. For example, the system 1120 can be configured to output instructions from the edge device(s) 108 to project a hologram on a wall nearby the user. The hologram can represent another user (such as a friend or family member of the user) that can ‘speak’ the emergency response information to the user.

The AR/VR system 1122 can be configured to output the emergency response information from at least the edge device(s) 108 using AR and/or VR technology described throughout this disclosure. In some implementations, the AR/VR system 112 can be a standalone system, such as a wearable device (e.g., googles, helmet, glasses, watch), that any of the users and/or emergency responders may use. Such wearable device(s) may receive instructions to present the output generated by the edge device(s) 108.

The temperature sensor 1124 (e.g., heat sensor, infrared sensor) can be configured to detect temperature conditions in a location, such as a building. The pressure sensor 1126 can be configured to detect pressure levels/conditions in the location. The motion sensor 1128 can be configured to detect movement and/or user presence in the location. The visual sensor 1130 can be configured to generate images and/or videos of the location. The audio sensor 1132 can be configured to detect sounds in the location. The signaling device(s) 112 can have any combination of sensors described herein. Any of the sensors described here can be configured to continuously and passively generate signals indicating conditions in the location. The sensor signals generated by these sensors can then be transmitted to the edge device(s) 108 and/or the backend computer system 1140 for further processing, and/or stored in the data store 1142 as the sensor signals 1166A-N.

In some implementations, the signaling device(s) 112 can include and/or be coupled to an apparatus having a user detector, fire detector, communication device, speaker, and a display device. The user detector can operate to detect user motion or presence around the signaling device(s) 112 over time. The user motion or presence can be recorded locally in the signaling device(s) 112 and/or at the edge device(s) 108. The user detector can be of various types, such as motion sensors and cameras. In addition or alternatively, the user detector can include a door/window sensor, door/window locks, etc. The fire detector can operate to detect presence and location of fire. Information on the fire presence and location can be recorded locally at the signaling device(s) 112 and/or at the edge device(s) 108. The fire detector can be of various types, such as a smoke detector and a heat sensor (e.g., a temperature sensor, an infrared sensor).

Still referring to FIGS. 11A and 11B, the backend computer system 1140 may include processor(s) 1143, a communication interface 1144, a model training engine 1146, a training simulation engine 1156, and/or an optional event classification and response engine 1164. In brief, the processor(s) 1143 can be configured to execute instructions to perform one or more of the operations described herein at the backend computer system 1140. The communication interface 1144 can be configured to provide communication between and amongst components of the backend computer system 1140 and other system components described in FIGS. 11A and 11B.

The model training engine 1146 can be configured to generate, train, and improve the models 1106A-N described herein. For example, the engine 1146 can be configured to train one or more of the models 1106A-N to detect an emergency from the sensor signals 1166A-N, classify the detected emergency, determine a spread and/or a severity of the detected emergency, and/or generate the emergency response information 1180. Once trained, the models 1166A-N may then be deployed on the edge, at the edge device(s) 108 for runtime use. The model training engine 1146 may include an emergency simulation engine 1148, an emergency response modeling engine 1150, a user behavior engine 1152, and/or an emergency path projection engine 1154.

The emergency simulation engine 1148 can be configured to simulate different types of emergencies in one or more different locations/types of locations using one or more of the sensor signals 1166A-N, the building information 1170, the emergency information 1172, the model training data 1176, and/or the emergency classification information 1174 from the data store 1142. The simulations can then be used by the model training engine 1146 to train the models 1106A-N described herein to accurately and efficiently detect emergencies from the sensor signals 1166A-N and determine the severity, type, and/or spread of the detected emergencies.

The emergency response modeling engine 1150 can be configured to train the models 1106A-N to generate appropriate emergency response strategies and/or instructions based on the simulated emergencies from the emergency simulation engine 1148. For example, the engine 1150 can be configured to model the emergency response information 1180 and/or the egress pathways and/or egress instructions 1182 based on the simulated emergencies, the types of emergencies, the predicted spreads of the emergencies, and/or the severity of the emergencies. The engine 1150 may also retrieve one or more of user information 1184 and/or trainee behavior data 1178 from the data store 1142 to model emergency response plans specific to different user/trainee behavior/characteristics.

The user behavior engine 1152 can be configured to model characteristics and/or behaviors of the relevant users at a location of an emergency, such as a building. The engine 1152 may receive the user information 1184 and/or the trainee behavior data 1178 from the data store 1142. The engine 1152 can process this information to determine whether a user, for example, gets very nervous or uncomfortable during an emergency and/or what type of guidance the user may require during a real-time emergency. Sometimes, the engine 1152 may also receive the sensor signals 1166A-N and process those signals to determine the user behavior/characteristics. Output generated by the engine 1152 can be provided to the emergency response modeling engine 1150, the training simulation engine 1156, and/or the event classification and response engine 1164.

The emergency path projection engine 1154 can be configured to model or otherwise predict how an emergency may spread throughout any location. For example, the engine 1154 can apply one or more AI techniques and/or machine learning algorithms to output from the emergency simulation engine 1184 to project how a simulated emergency may spread. The engine 1184 may also train the AI models 1106A-N described herein to project how real-time detected emergencies may spread.

The training simulation engine 1156 can be configured to generate training simulations to assist relevant users, such as building occupants and/or emergency responders, better prepare for responding to a real-time emergency. The training simulation engine 1156 may include a training simulation generator 1158, a training assessment engine 1160, and/or a training improvement engine 1162.

The training simulation generator 1158 can be configured to generate training simulation models 1168A-N, as described throughout this disclosure. For example, the generator 1158 can retrieve the building information 1170, the emergency information 1172, the trainee behavior data 1178, the emergency classification information 1174, the emergency response information 1180, the egress pathway and/or egress instructions 1182, the user information 1184, and/or the sensor signals 1166A-N from the data store 1142 for use in generating the models 1168A-N. The generator 1158 can generate at least one simulation training model 1168A-N based on identifying commonalities amongst the retrieved information. Some of these commonalities may include but are not limited to locations of sensors throughout the building (e.g., temperature sensors, sprinklers, etc.), egress strategies, emergency response instructions, building layout, and/or occupant information. The simulation training models 1168A-N can be applicable to different buildings and/or locations that may or may not share those commonalities. The generator 1158 may also generate simulation training models specific to a particular building and/or a particular building layout or other location. For example, a training model can be generated in real-time for emergency responders who are on route to a particular building that is on fire.

As another example, the generator 1158 can generate the models 1168A-N that can be applicable to numerous different buildings and/or locations to provide safety training procedures for building occupants and/or emergency responders. The models 1168A-N, once generated, can be distributed to computing devices (e.g., the user device(s) 116 and/or the emergency responder device(s) 120) of relevant users to undergo training and emergency preparedness procedures.

The training assessment engine 1160 can be configured to receive biometric data, sensor data, and other relevant data in response to the relevant stakeholders undergoing the simulation training models 1168A-N at their respective devices and process the received data to assess performance of the relevant stakeholders. In other words, the engine 1160 can determine how well each stakeholder performs a simulation training model. The engine 1160 may additionally or alternatively determine whether and to what extend egress or emergency response information should be adjusted for the particular stakeholder. The engine 1160 may determine whether the particular stakeholder becomes stressed during an emergency and how guidance can be improved to reduce the particular stakeholder's stress levels.

As an illustrative example, the engine 1160 can receive biometric data from sensors worn by the particular stakeholder while experiencing or otherwise undergoing the simulation training models 1168A-N. The received biometric data can be analyze by the ending 1160 to determine how stressed the trainee appeared/was during the simulation(s). Based on the determined stress levels and whether those stress values exceed predetermined threshold values (specific to the trainee and/or generic to a group or class of trainees having similar characteristics), the engine 1160 may determine improvements/modifications to the training simulation models 1168A-N and/or guidance/information provided to the particular trainee during a real-time emergency.

The training improvement engine 1162 can be configured to improve the training simulation models 1168A-N based at least in part on performance of the relevant stakeholders in the models 1168A-N and/or determinations made by the training assessment engine 1160. Predictive analytics, AI, and/or other machine learning techniques can be employed by the engine 1162 to improve the simulation training models 1168A-N. Over time, the engine 1162 may also access information stored in the data store 1142 (such as updated building information, updated user information, updated emergency response information, sensor signals indicating real-time or near real-time conditions in a particular location) to use as inputs for improving the simulation training models 1168A-N. In some implementations, any determinations made by the edge device(s) 108 during runtime/real-time monitoring and emergency detection may also be transmitted to the backend computer system 1140 and used by the training improvement engine 1162 as inputs for improving the models 1168A-N.

An iterative process of generating and improving the simulation training models 1168A-N, as described above, can be beneficial to ensure that trainees are exposed to varying emergency situations to improve their ability to cope with and respond to such situations in real-time. This iterative process can be beneficial to reduce stress and chaos that may occur in the event of a real-time emergency. This iterative process can further be beneficial to identify egress strategies and/or response plans that may be optimal to avoid stress and/or chaos during an emergency in any building layout and/or building.

In some implementations, the training simulation engine 1156 may identify optimal emergency response plans based on trainee performance of the training simulation models 1168A-N, then provide those identifications to the model training engine 1146. The engine 1146 may update one or more of the models 1106A-N and/or determinations made by the emergency response modeling engine 1150 according to the provided identifications. As another example, the identified optimal emergency response plans may also be stored in the data store 1142 as the egress pathways and/or egress instructions 1182 and/or the emergency information 1172. Such information 1182 and/or 1172 may then be accessed and/or used by the edge device(s) 108 when determining emergency response information to provide to relevant users during a real-time emergency.

The optional event classification and response engine 1164 can be configured to perform similar or same operations as the event classification module 1112 and/or the event response determinations module 1114 of the edge device(s) 108. For example, the engine 1164 may be configured to classify an emergency that was detected/identified by the edge device(s) 108 where a secure network connection is established between the edge device(s) 108 and the backend computer system 1140 and/or where sufficient bandwidth resources are available. As a result, some operations, such as classifying the emergency, may be offloaded to the cloud at the backend computer system 1140, while other critical operations, such as generating and/or transmitting emergency response information can be performed at the edge device(s) 108. The edge device(s) 108 may receive results from the operations performed at the engine 1164 of the backend computer system 1140 in real-time or near real-time so that the edge device(s) 108 can continue to seamless perform operations relating to identify, responding to, and/or mitigating the emergency.

In some implementations, one or more of the operations performed by components of the backend computer system 1140 may additionally or alternatively be performed by the components of the edge device(s) 108. Similarly, one or more of the operations performed by the components of the edge device(s) 108 can additionally or alternatively be performed by the components of the backend computer system 1140. Sometimes, determining which of the edge device(s) 108 or the backend computer system 1140 performs the operations may depend on available compute resources, secure network connectivity, and/or bandwidth.

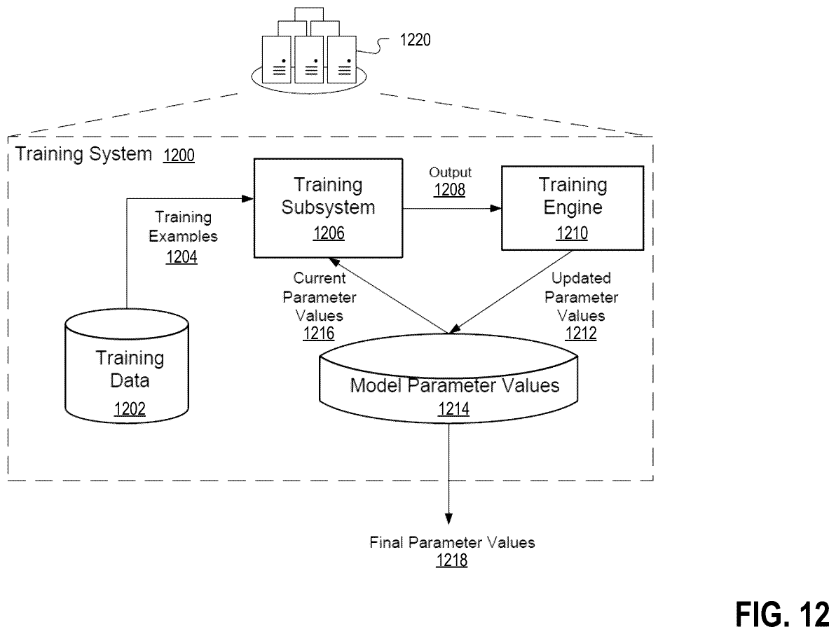

FIG. 12 depicts an example system 1200 for training one or more models described herein. The training system 1200 can be hosted within a data center 1220, which can be a distributed computing system having hundreds or thousands of computers, computing systems, edge devices, and/or other computing devices in one or more locations.

The training system 1200 may include a training subsystem 1206 that can be configured to implement operations of AI and/or machine learning models described herein. Where the training subsystem 1206 may use a neural network, the training subsystem 1206 can be configured to implement operations of each layer of the neural network according to an architecture of the neural network.

The training subsystem 1206 may compute operations of statistical models using current parameter values 1216 stored in a collection of model parameter values data store 1214. Although illustrated as being logically separated, the model parameter values data store 1214 and the software or hardware modules performing the operations may be located on the same computing device, edge device, and/or on the same memory device.

The training subsystem 1206 can generate, for each training example 1204, an output 1280 (e.g., an emergency scenario, an emergency response plan, a spread of an emergency). A training engine 1210 can analyze the output 1208 and compares the output 1208 to labels in the training examples 1204 that may indicate target outputs for each training example 1204. The training engine 1210 can then generate updated model parameter values 1212 for storage in the data store 1214 by using any updating technique (e.g., stochastic gradient descent with backpropagation).

After training is complete, the training system 1200 can provide a final set of parameter values 1218 to a system, such as a remote backend computer system and/or an edge device for use in generating, training, and executing the AI and/or machine learning models described herein. The training system 1200 can provide the final set of model parameter values 1218 by a wired or wireless connection to the remote backend computer system and/or the edge device, as an illustrative example. Refer to U.S. application Ser. No. 16/258,022, entitled “Home Emergency Guidance and Advisement System,” with a priority date of Jan. 25, 2019 for further discussion, the disclosure of which is incorporated herein by reference in its entirety.

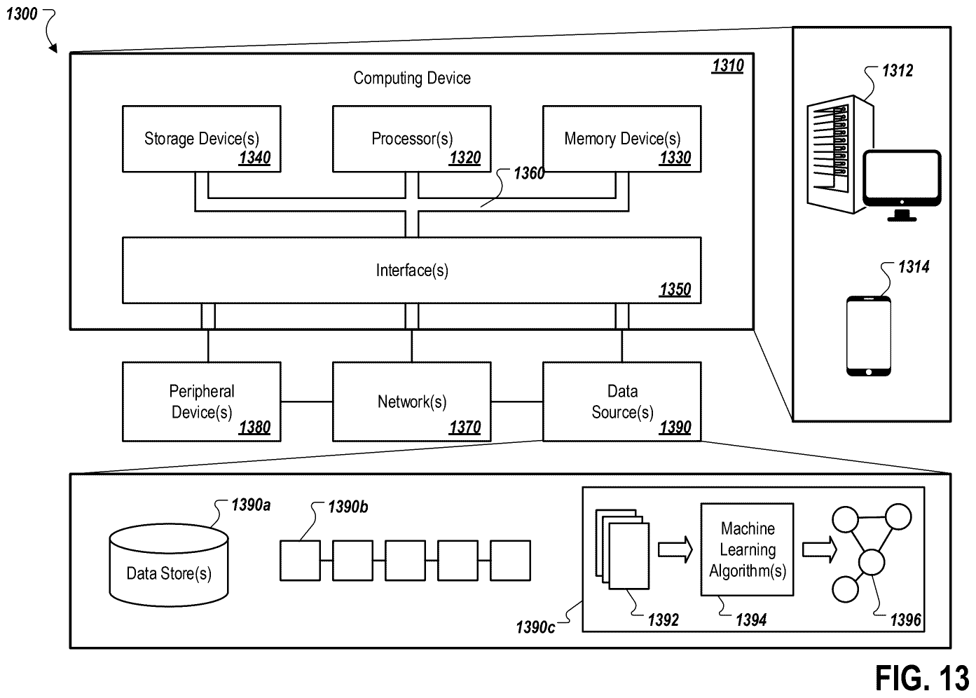

FIG. 13 is a schematic diagram that shows an example of a computing system 1300 that can be used to implement the techniques described herein. The computing system 1300 includes one or more computing devices (e.g., computing device 1310), which can be in wired and/or wireless communication with various peripheral device(s) 1380, data source(s) 1390, and/or other computing devices (e.g., over network(s) 1370). The computing device 1310 can represent various forms of stationary computers 1312 (e.g., workstations, kiosks, servers, mainframes, edge computing devices, quantum computers, etc.) and mobile computers 1314 (e.g., laptops, tablets, mobile phones, personal digital assistants, wearable devices, etc.). In some implementations, the computing device 1310 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1310, and an entire system can be made up of multiple devices communicating with each other. For example, the computing device 1310 can be part of a computing system that includes a network of computing devices, such as a cloud-based computing system, a computing system in an internal network, or a computing system in another sort of shared network. Processors of the computing device (1310) and other computing devices of a computing system can be optimized for different types of operations, secure computing tasks, etc. The components shown herein, and their functions, are meant to be examples, and are not meant to limit implementations of the technology described and/or claimed in this document.

The computing device 1310 includes processor(s) 1320, memory device(s) 1330, storage device(s) 1340, and interface(s) 1350. Each of the processor(s) 1320, the memory device(s) 1330, the storage device(s) 1340, and the interface(s) 1350 are interconnected using a system bus 1360. The processor(s) 1320 are capable of processing instructions for execution within the computing device 1310, and can include one or more single-threaded and/or multi-threaded processors. The processor(s) 1320 are capable of processing instructions stored in the memory device(s) 1330 and/or on the storage device(s) 1340. The memory device(s) 1330 can store data within the computing device 1310, and can include one or more computer-readable media, volatile memory units, and/or non-volatile memory units. The storage device(s) 1340 can provide mass storage for the computing device 1310, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1350 can include various communications interfaces (e.g., USB, Near-Field Communication (NFC), Bluetooth, WiFi, Ethernet, wireless Ethernet, etc.) that can be coupled to the network(s) 1370, peripheral device(s) 1380, and/or data source(s) 1390 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1350 can include a control interface that receives commands from an input device (e.g., operated by a user) and converts the commands for submission to the processors 1320. The interface(s) 1350 can include a display interface that includes circuitry for driving a display to present visual information to a user. The interface(s) 1350 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1370 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1310 can communicate with the peripheral device(s) 1380, the data source(s) 1390, and/or other computing devices over the network(s) 1370. In some implementations, the computing device 1310 can directly communicate with the peripheral device(s) 1380, the data source(s), and/or other computing devices.

The peripheral device(s) 1380 can provide input/output operations for the computing device 1310. Input devices (e.g., keyboards, pointing devices, touchscreens, microphones, cameras, scanners, sensors, etc.) can provide input to the computing device 1310 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1310 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1390 can provide data for use by the computing device 1310, and/or can maintain data that has been generated by the computing device 1310 and/or other devices (e.g., data collected from sensor devices, data aggregated from various different data repositories, etc.). In some implementations, one or more data sources can be hosted by the computing device 1310 (e.g., using the storage device(s) 1340). In some implementations, one or more data sources can be hosted by a different computing device. Data can be provided by the data source(s) 1390 in response to a request for data from the computing device 1310 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1390a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1390b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1390c. The machine learning system(s) 1390c, for example, can be used to analyze data from various sources (e.g., data provided by the computing device 1310, data from the data store(s) 1390a, data from the blockchain(s) 1390b, and/or data from other data sources), to identify patterns in the data, and to draw inferences from the data patterns. In general, training data 1392 can be provided to one or more machine learning algorithms 1394, and the machine learning algorithm(s) can generate a machine learning model 1396. Execution of the machine learning algorithm(s) can be performed by the computing device 1310, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1-7. (canceled)

8. A system for classifying emergencies, the system comprising:
a computer system configured to perform operations comprising:
receiving sensor signals from a plurality of devices at a location;
applying an artificial intelligence (AI) model to the sensor signals to identify an emergency event, wherein the AI model was trained, by a backend computer system that is remote from the location, to (i) identify a type of emergency based on the sensor signals that exceed respective expected threshold levels, (ii) determine a spread of the emergency event based on analyzing (a) strength of at least one of the sensor signals received from a device of the plurality of devices and (b) proximity of other devices among the plurality of devices relative to the device associated with the at least one of the sensor signals, and (iii) determine a severity level of the emergency event based on comparing the sensor signals to expected threshold values that are associated with the type of the emergency event;
generating, based on output from the AI model indicating the emergency event, emergency response information, wherein generating the emergency response information comprises dynamically generating egress instructions for a user associated with the location to an egress point at the location that is identified by the emergency response information; and
returning the emergency response information with the egress instructions to a device of the user for presentation in an augmented reality (AR) interface of said device,
wherein returning the emergency response information causes said device to selectively display a portion of the egress instructions as a textual prompt and a graphical element that overlays a real-time view of the user's current location presented in the AR interface, wherein the textual prompt comprises a current egress instruction and next egress instruction,
determining movement of the user closer to the egress point that is identified by the emergency response information, and
dynamically modifying the textual prompt and an appearance of the graphical element that overlays the real-time view of the user's current location in the AR interface as the user moves closer to the egress point that is identified by the emergency response information.

9. The system of claim 8, wherein returning the emergency response information comprises automatically transmitting the emergency response information to computing devices of first responders.

10. A method for classifying events, the method comprising:
receiving, by an edge device deployed at a location, sensor signals from a plurality of devices at the location that includes at least the edge device;
identifying, by the edge device, an event using a mathematical equation, wherein the mathematical equation determines information about the event at the location based upon at least: (i) event parameters that are derived from the use of an artificial intelligence (AI) model that was trained by a backend computer system that is remote from the location and (ii) the sensor signals, wherein the AI model was trained to (i) identify a type of the event based on the sensor signals that exceed respective expected threshold levels, (ii) determine a spread of the event based on analyzing (a) strength of at least one of the sensor signals received from a device of the plurality of devices and (b) proximity of other devices among the plurality of devices relative to the device associated with the at least one of the sensor signals, and (iii) determine a severity level of the event based on comparing the sensor signals to expected threshold values that are associated with the type of the event;
generating, based on identifying the event, emergency response information, wherein generating the emergency response information comprises dynamically generating egress instructions for a user associated with the location to an egress point at the location that is identified by the emergency response information; and
returning, by the edge device, the emergency response information with the egress instructions for output using an AR interface,
wherein returning the emergency response information causes a portion of the egress instructions to be presented in the AR interface as a textual prompt and a graphical element that overlays a real-time view of a user's current location, wherein the textual prompt comprises a current egress instruction,
determining, by the edge device, movement of the user closer to the egress point that is identified by the emergency response information, and
dynamically modifying, by the edge device and based on the determined movement of the user, the textual prompt and an appearance of the graphical element that overlays the real-time view of the user's current location in the AR interface as the user moves closer to the egress point that is identified by the emergency response information.

11. The method of claim 10, wherein the sensor signals comprise at least one of: temperature signals from one or more temperature sensors, audio signals from one or more audio sensors, or movement signals from one or more motion sensors.

12-13. (canceled)

14. The method of claim 10, wherein the event comprises an emergency.

15. The method of claim 10, wherein the AI model was trained to generate output indicating an event classification for the event.

16. (canceled)

17. The method of claim 10, wherein returning the emergency response information comprises transmitting the emergency response information to a computing device of an emergency responder.

18-19. (canceled)

20. The system of claim 8, wherein the backend computer system is further configured to:
generate synthetic training data indicating one or more other types of emergencies; and
train the AI model based on the synthetic training data.

21. The system of claim 8, wherein returning the emergency response information comprises:
identifying, based on the emergency response information, relevant emergency responders to provide assistance to users at the location; and
automatically transmitting the emergency response information to computing devices of the identified emergency responders.

22. The system of claim 21, wherein the emergency response information transmitted to the computing devices of the identified emergency responders further comprises information about the users at the location.

23. The system of claim 8, wherein the backend computer system is further configured to iteratively adjust the AI model based at least in part on the emergency response information.

24. (canceled)

25. The system of claim 8, wherein the emergency response information comprises stay-in-place instructions.

26. The system of claim 8, wherein returning the emergency response information comprises returning the emergency response information to a central monitoring system that is remote from the location.

27. The system of claim 26, wherein the computer system is further configured to (i) identify relevant emergency responders based on the emergency response information and (ii) transmit a portion of the emergency response information to computing devices of the identified emergency responders for presentation in respective GUI displays.

28. The system of claim 8, wherein the computer system is further configured to passively monitor activity at the location based on (i) continuously receiving the sensor signals from the plurality of devices and (ii) assessing the continuously received sensor signals against one or more respective threshold levels indicative of normal conditions at the location.

29. The system of claim 28, wherein, in response to determining that at least one of the continuously received sensor signals exceeds a respective threshold level indicative of the normal conditions at the location, performing the applying step.

30. The system of claim 8, wherein the device of the user is configured to dynamically and automatically enlarge an appearance of the graphical elements that overlay the real-time view of the user's current location in the AR interface as the user moves closer to a next location associated with the next egress instruction.

31. The system of claim 8, wherein the graphical elements comprise directional arrows.

32. The method of claim 10, wherein the device of the user is configured to dynamically and automatically enlarge an appearance of the graphical elements that overlay the real-time view of the user's current location in the AR interface as the user moves closer to a next location associated with the next egress instruction.

33. The method of claim 10, wherein the graphical elements comprise directional arrows.
